(19) United States
(12) Patent Application Publication
(10) Pub. No.: US 2026/0058355 A1
(43) Pub. Date: Feb. 26, 2026

(54) Antenna Based Response

(71) Applicant: Cirque Corporation, Sandy, UT (US)

(72) Inventors: Jon Bertrand, Taylorsville, UT (US); Brian Monson, Farmington, UT (US)

(73) Assignee: Cirque Corporation, Sandy, UT (US)

(21) Appl. No.: 19/184,903

(22) Filed: Apr. 21, 2025

Related U.S. Application Data
(63) Continuation-in-part of application No. 18/809,924, filed on Aug. 20, 2024, now Pat. No. 12,422,960.

(51) Int. Cl. H01Q 1/22; G06F 3/0354; H01Q 7/00

(52) U.S. Cl. CPC H01Q 1/2258; G06F 3/03547; H01Q 7/00

(57) ABSTRACT

A capacitance module may include a set of electrodes; processing resources in communication with the set of electrodes; an embedded antenna in communication with the processing resources; and memory in communication with the processing resources; wherein the memory includes programmed instructions that cause the processing resources, when executed, to receive a capacitance input from the set of electrodes; compare an input attribute of the capacitance input to a stored attribute; and send an instruction to trigger a response with the embedded antenna based, at least in part, on the comparison.

### CROSS REFERENCE TO RELATED APPLICATIONS

This application is a continuation-in-part of U.S. patent application Ser. No. 18/809,924 titled Determining an Unprompted Input filed on Aug. 20, 2024. U.S. patent application Ser. No. 18/809,924 is herein incorporated by reference for all that it discloses.

### FIELD OF THE DISCLOSURE

This disclosure relates generally to systems and methods for embedded antenna incorporated into electronic devices. In particular, this disclosure relates to systems and methods for calibrating an embedded antenna.

### BACKGROUND

Antenna are often incorporated into many electronic devices. NFC antennas are being incorporated into more electronic devices for payment transactions, authentication, and other types of data exchanges.

An example of an NFC antenna incorporated into an electronic device is disclosed in U.S. Pat. No. 10,275,05 issued to Katsuhisa Orihara. This reference discloses a touch pad antenna device to ensure communication performance while downsizing the antenna and while maintaining operation performance of a touch pad, and an electronic apparatus incorporating this touch pad antenna device. A touch pad antenna device provided along with a capacitance type touch pad mounted on an electronic apparatus and communicates with an external apparatus via an electromagnetic field signal, having an antenna coil inductively coupled to the external apparatus and arranged by winding around a conducting wire such that conducting wires opposing in width direction via an opening will be close to each other, wherein the antenna coil is arranged along outer edge of a sheet-like electrode section constituting the touch pad.

Another example of an NFC antenna incorporated into an electronic device is disclosed in U.S. Patent Publication No. US Patent Publication No. 2014/0078094 issued to Songnan Yang. This reference discloses that when threshold values for the capacitive sensors in a touch pad are periodically updated to allow for drift in these values, the updating process may be suspended while a nearby radio antenna is transmitting. Such transmissions from an antenna that is located next to the touch pad could otherwise significantly alter the effective capacitance in these sensors and thereby make the touch pad unreliable for registering a touch. Even though the capacitance may return to normal fairly quickly after the transmission stops, the moving average technique typically used to smooth out short term variation may incorporate the period of changed capacitance and thereby extend the period of unreliability, but suspending the update process during a transmission can avoid this problem.

Each of these references are herein incorporated by reference for all that they disclose.

### SUMMARY

In some embodiments, a capacitance module may include a set of electrodes; processing resources in communication with the set of electrodes; an embedded antenna in communication with the processing resources; and memory in communication with the processing resources where the memory includes programmed instructions that cause the processing resources, when executed, to receive a capacitance input from the set of electrodes; compare an input attribute of the capacitance input to a stored attribute; and send an instruction to trigger a response with the embedded antenna based, at least in part, on the comparison.

The response may include increasing the power level of the embedded antenna.

The response may include turning on the embedded antenna.

The response may include disabling the embedded antenna.

The response may include deciphering a modulation pattern from an external antenna device with the embedded antenna.

The response may include sending an instruction to cause the embedded antenna to send a polling signal.

The response may include sending an instruction to cause the embedded antenna to send an interrogation signal.

The response may include confirming a presence of an external antenna device within a range of the embedded antenna.

The programmed instructions may further cause the processing resources to obtain the stored attribute.

Obtaining the stored attribute may include recording a capacitance signature with the capacitance electrodes in response to receiving a typing input from a keyboard that may be incorporated into a device that also incorporates the capacitance module.

Obtaining the stored attribute may include recording a capacitance signature with the capacitance electrodes in response to receiving a camera input from a camera that may be incorporated into a device that also incorporates the capacitance module.

Obtaining the stored attribute may include recording a capacitance signature with the embedded antenna in response to a tap on the device incorporating the capacitance module.

Obtaining the stored attribute may include recording a capacitance signature with the capacitance electrodes in response to recognizing signal pattern of an external antenna device.

Obtaining the stored attribute may include recording a capacitance signature with the capacitance electrodes in response to prompting a user to perform an action with a device that incorporates the capacitance module.

The action with the device may include placing a user's hand adjacent to the capacitance module.

The action with the device may include making a touch input on a touch surface incorporating the capacitance electrodes with the user's hand.

The action with the device may include making a non-contact gesture input above a touch surface incorporating the capacitance electrodes with the user's hand.

The action with the device may include placing an external antenna device above a touch surface incorporating the capacitance electrodes.

The programmed instructions may further include modifying the stored attribute by obtaining a subsequent attribute and modifying the stored attribute based on the subsequent attribute.

The processing resources may include a capacitance controller with capacitance processing logic and an antenna controller with antenna processing logic.

The processing resources may include a single controller having capacitance processing logic and antenna processing logic.

In some embodiments, a computer-program product for using a capacitance module may include a non-transitory computer-readable medium storing instructions executable with a controller to receive a capacitance input from the set of electrodes; compare an input attribute of the capacitance input to a stored attribute; and send an instruction to trigger a response with an embedded antenna based, at least in part, on the comparison.

The response may include disabling the embedded antenna.

The response may include deciphering a modulation pattern from an external antenna device with the embedded antenna.

The response may include sending an instruction to cause the embedded antenna to send an interrogation signal.

The response may include sending an instruction to cause the embedded antenna to send an interrogation signal.

The response may include confirming a presence of an external antenna device within a range of the embedded antenna.

The programmed instructions may further cause the processing resources to obtain the stored attribute.

Obtaining the stored attribute may include recording a capacitance signature with the capacitance electrodes in response to receiving a typing input from a keyboard that may be incorporated into a device that also incorporates the capacitance module.

Obtaining the stored attribute may include recording a capacitance signature with the capacitance electrodes in response to recognizing signal pattern of an external antenna device.

Obtaining the stored attribute may include recording a capacitance signature with the capacitance electrodes in response to prompting a user to perform an action with a device that incorporates the capacitance module.

Obtaining the stored attribute may include recording a capacitance signature with the embedded antenna in response to a tap on the device incorporating the capacitance module.

Obtaining the stored attribute may include recording a capacitance signature with the capacitance electrodes in response to receiving a camera input from a camera that may be incorporated into a device that also incorporates the capacitance module.

The programmed instructions may further cause the processing resources to modify the stored attribute by obtaining a subsequent attribute and modifying the stored attribute based on the subsequent attribute.

In some embodiments, a method of using a capacitance module may include receiving a capacitance input from the set of electrodes; comparing an input attribute of the capacitance input to a stored attribute; and sending an instruction to trigger a response with an embedded antenna based, at least in part, on the comparison.

The method may include obtaining the stored attribute.

The method may include modifying the stored attribute by obtaining a subsequent attribute and modifying the stored attribute based on the subsequent attribute.

In some embodiments, an antenna module may include an embedded antenna; processing resources in communication with the embedded antenna; and memory in communication with the processing resources where the memory includes programmed instructions that cause the processing resources, when executed, to receive an input from the embedded antenna; compare an input attribute of the input to a stored attribute; and send an instruction to trigger a response with the embedded antenna based, at least in part, on the comparison.

The antenna module may include a set of capacitance sense electrodes in communication with the processing resources.

The response may include disabling the capacitance electrodes.

The response may include increasing the power level of the embedded antenna.

The response may include turning on the embedded antenna.

The response may include deciphering a modulation pattern from an external antenna device with the embedded antenna.

The response may include rejecting the input from the embedded antenna as a signal from an external antenna device.

The response may include disabling the embedded antenna.

The response may include sending a message to a user.

The response may include sending a polling signal with the embedded antenna.

The response may include sending an instruction to cause the embedded antenna to send an interrogation signal.

The antenna the programmed instructions may further cause the processing resources to obtain the stored attribute.

Obtaining the stored attribute may include recording an inductive signature with the embedded antenna in response to receiving a typing input from a keyboard that may be incorporated into a device that also incorporates the antenna module.

Obtaining the stored attribute may include recording an inductive signature with the embedded antenna in response to receiving a camera input from a camera that may be incorporated into a device that also incorporates the antenna module.

Obtaining the stored attribute may include recording an inductive signature with the embedded antenna in response to a tap on the device incorporating the embedded antenna.

Obtaining the stored attribute may include recording an inductive signature with the embedded antenna in response to prompting a user to perform an action with a device that incorporates the antenna module.

Obtaining the stored attribute may include recording an inductive signature with the embedded antenna in response to recognizing signal pattern of an external antenna device.

Obtaining the stored attribute may include recording an inductive signature with the embedded antenna in response to prompting a user to place a device that incorporates the antenna module near a metal object.

The action with the device may include placing a user's hand adjacent to the embedded antenna.

The action with the device may include making a touch input on a touch surface incorporating the capacitance electrodes with the user's hand.

The action with the device may include making a non-contact gesture input above a touch surface incorporating the capacitance electrodes with the user's hand.

The action with the device may include placing an external antenna device above a touch surface incorporating the capacitance electrodes.

The programmed instructions may further include modifying the stored attribute by obtaining a subsequent attribute and modifying the stored attribute based on the subsequent attribute.

In some embodiments, a computer-program product for using an antenna module may include a non-transitory computer-readable medium storing instructions executable with a controller to receive an input from an embedded antenna incorporated into an antenna module; compare an input attribute of the input to a stored attribute; and send an instruction to trigger a response with the embedded antenna based, at least in part, on the comparison.

The response may include disabling the capacitance electrodes also incorporated into the antenna module.

The response may include increasing the power level of the embedded antenna.

The response may include turning on the embedded antenna.

The response may include deciphering a modulation pattern from an external antenna device with the embedded antenna.

The response may include rejecting the input from the embedded antenna as a signal from an external antenna device.

The response may include disabling the embedded antenna.

The response may include sending a message to a user.

The response may include sending a polling signal with the embedded antenna.

The response may include sending an instruction to cause the embedded antenna to send an interrogation signal.

The programmed instructions may further cause the processing resources to obtain the stored attribute.

Obtaining the stored attribute may include recording an inductive signature with the embedded antenna in response to receiving a typing input from a keyboard that may be incorporated into a device that also incorporates the antenna module.

Obtaining the stored attribute may include recording an inductive signature with the embedded antenna in response to receiving a camera input from a camera that may be incorporated into a device that also incorporates the antenna module.

Obtaining the stored attribute may include recording an inductive signature with the embedded antenna in response to a tap on the device incorporating the embedded antenna.

Obtaining the stored attribute may include recording an inductive signature with the embedded antenna in response to prompting a user to perform an action with a device that incorporates the antenna module.

Obtaining the stored attribute may include recording an inductive signature with the embedded antenna in response to recognizing signal pattern of an external antenna device.

Obtaining the stored attribute may include recording an inductive signature with the embedded antenna in response to prompting a user to place a device that incorporates the antenna module near a metal object.

The programmed instructions may further include modifying the stored attribute by obtaining a subsequent attribute and modifying the stored attribute based on the subsequent attribute.

In some embodiments, a method for using an antenna module may include receiving an input from an embedded antenna incorporated into an antenna module; comparing an input attribute of the input to a stored attribute; and sending an instruction to trigger a response with the embedded antenna based, at least in part, on the comparison.

The method may include obtaining the stored attribute.

The method may include modifying the stored attribute by obtaining a subsequent attribute and modifying the stored attribute based on the subsequent attribute.

### BRIEF DESCRIPTION OF THE DRAWINGS

FIG. 1 depicts an example of an electronic device in accordance with the disclosure.

FIG. 2 depicts an example of a substrate with a first set of electrodes and a second set of electrodes in accordance with the disclosure.

FIG. 3 depicts an example of a touch pad in accordance with the disclosure.

FIG. 4 depicts an example of a touch screen in accordance with the disclosure.

FIG. 5 depicts an example of a stack of layers in accordance with the disclosure.

FIG. 6 depicts an example of a user prompt in accordance with the disclosure.

FIG. 7 depicts an example of a typing input in accordance with the disclosure.

FIG. 8 depicts an example of a card input in accordance with the disclosure.

FIG. 9 depicts an example of a taping input layer in accordance with the disclosure.

FIG. 10 depicts an example of a capacitance module in accordance with the disclosure.

FIG. 11 depicts an example of a capacitance module in accordance with the disclosure.

FIG. 12 depicts an example of an antenna module in accordance with the disclosure.

FIG. 13 depicts an example of an antenna module in accordance with the disclosure.

FIG. 14 depicts an example of a capacitance module in accordance with the disclosure.

FIG. 15 depicts an example of a module in accordance with the disclosure.

FIG. 16A depicts an example of an electronic device in accordance with the disclosure.

FIG. 16B depicts an example of an electronic device in accordance with the disclosure.

FIG. 17 depicts an example of a method of using an antenna in accordance with the disclosure.

FIG. 18 depicts an example of a method of using an antenna in accordance with the disclosure.

FIG. 19 depicts an example of a method of using an antenna in accordance with the disclosure.

FIG. 20 depicts an example of a method of using an antenna in accordance with the disclosure.

FIG. 21 depicts an example of a method of using an antenna in accordance with the disclosure.

FIG. 22 depicts an example of a method of using an antenna in accordance with the disclosure.

FIG. 23 depicts an example of a method of using an antenna in accordance with the disclosure.

FIG. 24 depicts an example of a method of using an antenna in accordance with the disclosure.

FIG. 25 depicts an example of a method of using an antenna in accordance with the disclosure.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION OF THE INVENTION

This description provides examples, and is not intended to limit the scope, applicability, or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted, or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

For purposes of this disclosure, the term “aligned” generally refers to being parallel, substantially parallel, or forming an angle of less than 35.0 degrees. For purposes of this disclosure, the term “transverse” generally refers to perpendicular, substantially perpendicular, or forming an angle between 55.0 and 125.0 degrees. For purposes of this disclosure, the term “length” generally refers to the longest dimension of an object. For purposes of this disclosure, the term “width” generally refers to the dimension of an object from side to side and may refer to measuring across an object perpendicular to the object's length.

For purposes of this disclosure, the term “electrode” may generally refer to a portion of an electrical conductor intended to be used to make a measurement, and the terms “route” and “trace” generally refer to portions of an electrical conductor that are not intended to make a measurement. For purposes of this disclosure in reference to circuits, the term “line” generally refers to the combination of an electrode and a “route” or “trace” portions of the electrical conductor. For purposes of this disclosure, the term “Tx” generally refers to a transmit line, electrode, or portions thereof, and the term “Rx” generally refers to a sense line, electrode, or portions thereof.

For the purposes of this disclosure, the term “electronic device” may generally refer to devices that can be transported and include a battery and electronic components. Examples may include a laptop, a desktop, a mobile phone, an electronic tablet, a personal digital device, a watch, a gaming controller, a gaming wearable device, a wearable device, a measurement device, an automation device, a security device, a display, a computer mouse, a vehicle, an infotainment system, an audio system, a control panel, another type of device, an athletic tracking device, a tracking device, a card reader, a purchasing station, a kiosk, or combinations thereof.

It should be understood that use of the terms “capacitance module,” “touch pad” and “touch sensor” throughout this document may be used interchangeably with “capacitive touch sensor,” “capacitive sensor,” “capacitance sensor,” “capacitive touch and proximity sensor,” “proximity sensor,” “touch and proximity sensor,” “touch panel,” “trackpad,” “touch pad,” and “touch screen. ”The capacitance module may be incorporated into an electronic device.

It should also be understood that, as used herein, the terms “vertical,” “horizontal,” “lateral,” “upper,” “lower,” “left,” “right,” “inner,” “outer,” etc., can refer to relative directions or positions of features in the disclosed devices and/or assemblies shown in the Figures. For example, “upper” or “uppermost” can refer to a feature positioned closer to the top of a page than another feature. These terms, however, should be construed broadly to include devices and/or assemblies having other orientations, such as inverted or inclined orientations where top/bottom, over/under, above/below, up/down, and left/right can be interchanged depending on the orientation.

In some cases, the capacitance module is located within a housing. The capacitance module may be underneath the housing and capable of detecting objects outside of the housing. In examples, where the capacitance module can detect changes in capacitance through a housing, the housing is a capacitance reference surface. For example, the capacitance module may be disclosed within a cavity formed by a keyboard housing of a computer, such as a laptop or other type of computing device, and the sensor may be disposed underneath a surface of the keyboard housing. In such an example, the keyboard housing adjacent to the capacitance module is the capacitance reference surface. In some examples, an opening may be formed in the housing, and an overlay may be positioned within the opening. In this example, the overlay is the capacitance reference surface. In such an example, the capacitance module may be positioned adjacent to a backside of the overlay, and the capacitance module may sense the presence of the object through the thickness of the overlay. For the purposes of this disclosure, the term “reference surface” may generally refer to a surface through which a pressure sensor, a capacitance sensor, or another type of sensor is positioned to sense a pressure, a presence, a position, a touch, a proximity, a capacitance, a magnetic property, an electric property, another type of property, or another characteristic, or combinations thereof that indicates an input. For example, the reference surface may be a housing, an overlay, or another type of surface through which the input is sensed. In some examples, the reference surface has no moving parts. In some examples, the reference surface may be made of any appropriate type of material, including, but not limited to, plastics, glass, a dielectric material, a metal, another type of material, or combinations thereof.

For the purposes of this disclosure, the term “display” may generally refer to a display or screen that is not depicted in the same area as the capacitive reference surface. In some cases, the display is incorporated into a laptop where a keyboard is located between the display and the capacitive reference surface. In some examples where the capacitive reference surface is incorporated into a laptop, the capacitive reference surface may be part of a touch pad. Pressure sensors may be integrated into the stack making up the capacitance module. However, in some cases, the pressure sensors may be located at another part of the laptop, such as under the keyboard housing, but outside of the area used to sense touch inputs, on the side of the laptop, above the keyboard, to the side of the keyboard, at another location on the laptop, or at another location. In examples where these principles are integrated into a laptop, the display may be pivotally connected to the keyboard housing. The display may be a digital screen, a touch screen, another type of screen, or combinations thereof. In some cases, the display is located on the same device as the capacitive reference surface, and in other examples, the display is located on another device that is different from the device on which the capacitive reference surface is located. For example, the display may be projected onto a different surface, such as a wall or projector screen. In some examples, the reference surface may be located on an input or gaming controller, and the display is located on a wearable device, such as a virtual reality or augmented reality screen. In some cases, the reference surface and the display are located on the same surface, but on separate locations on that surface. In other examples, the reference surface and the display may be integrated into the same device, but on different surfaces. In some cases, the reference surface and the display may be oriented at different angular orientations with respect to each other.

For the purposes of this disclosure, the term “antenna module” may generally refer to a module with an embedded antenna. The antenna module may include processing resources, such as a controller or other types of processing resources. The processing resources may cause the antenna module to send antenna signals, receive antenna signal, process received antenna signals, perform other antenna-related tasks, or combinations thereof. The antenna may be mounted on a printed circuit board or on another surface. In some cases, the antenna is a near field communication (NFC) Antenna. The antenna module may include both hardware and software to carry out the functions of the module antenna. In some embodiments, the antenna module may also include other sensors and circuitry that are dedicated to functions outside of the antenna's function. For example, the antenna module may include at least one capacitance sensor/electrode, a strain gauge, a pressure sensor, an inductive coil, a magnet, a haptic actuator, another feature, or combinations thereof. The antenna module may store some of the programmed instructions for operating the antenna and/or processing received antenna signals locally. In other examples, the antenna module may have access to remotely stored programmed instructions that are located in an electronic device that contains the antenna module or that are located at a location that is accessible through a wireless connection, such as a cloud based location.

For the purposes of this disclosure, the term “input attribute” may generally refer to an attribute of a received signal and/or derived from a received signal. In some examples, the input attribute is characteristic of or found in the raw received data. In other examples, the input attribute is a characteristics of or found in processed data. The input attribute may be part of a received antenna input, a received capacitance input, another received input, or combinations thereof. The input attribute may include a dimension attribute, a movement attribute, signal attribute, an image attribute, another type of attribute, or combinations thereof.

For the purposes of this disclosure, the term “dimension attribute” may generally refer to a dimension of the object (e.g., finger, thumb, palm, stylus, etc.) being measured. In some examples, a dimension attribute may include a length, a width, a surface area, a distance between features of the object, a diagonal measurement of an object, a diagonal measurement of a feature of an object, a curvature of an edge of the object, a length of an edge of the object, a cross section of the object, a cross section of a portion of the object, a cross section of a feature of an object, a length of a feature of an object, a length of a central axis of the object, an angular orientation of a central axis of the object, a location of a central axis of a feature of the object, an angular orientation of a feature of the object, another dimension, or combinations thereof. A feature of an object may include a protuberance of an object, a discontinuity of an object, an appendage of an object, another feature, or combinations thereof. A dimension attribute may be a finger dimension attribute, a thumb dimension attribute, a palm dimension attribute, a stylus dimension attribute, a proximity dimension attribute, another type of dimension attribute, or combinations thereof.

For the purposes of this disclosure, the term “movement attribute” may generally refer to a movement of the object (e.g., finger, thumb, palm, stylus, etc.) being measured. In some examples, a dimension attribute may include a distance traveled by the object, a rotation of the object, an angular distance of the object rotated, a nutation of the object, a movement direction of the object, a pattern of movement of the object, a speed of movement of the object, an initial speed of movement of the object, a continuing speed (i.e., a speed after the initial speed) of the object, a scrolling pattern of the object, a duration of movement of the object, a number of cycles of movement of the object within a predetermined time period, a swiping stroke distance, a swiping speed, a swiping angle, a number of swipes, a swiping rotation, a wiggle of the object, a wiggle variation in the object, a stability of the object, a static position of the object, a duration of a static position of the object, a scrolling stroke distance, a scrolling speed, a scrolling angle, a number of scrolling cycles, a scrolling rotation, a curvature of movement, a trajectory of movement, a location of the movement, a zoom stroke distance, a zoom in speed, a zoom out speed, a zoom pinch angle, a number of zoom cycles, a zoom pinch rotation, a curvature of movement of a zoom, a trajectory of a zoom movement, a location of a zoom movement, a difference in speeds between different parts of the object, a difference in angular speeds between different parts of the object, a difference in rotations between different parts of the object, a distal speed of an object, a proximal speed of an object, a rotational velocity of an object, a shape formed by movement of the object, the straightness of a line formed by the movement, a change in length of the object, a change in width of the object, a change in rotation of the object, a change in surface area of the object, a change in a dimension of the object, a change in a shape of the object, a change in a curvature of an edge of the object, a change in central axis position of the object, a change in central axis position of a feature of the object, a change in orientation of the object or feature, a frequency of change in position of the object or feature, a frequency of movement of the object or feature, a change in relative angular position of between features of the object, a change in relative angular position of between central axes of features of the object, another type of movement attribute, or combinations thereof. A movement attribute may be a finger movement attribute, a thumb movement attribute, a palm movement attribute, a stylus movement attribute, a proximity movement attribute, a differential of movement between different parts of an object, a relative movement, an absolute movement, another type of movement attribute, or combinations thereof.

For the purposes of this disclosure, the term “signal attribute” may generally refer to a signal of the capacitance measurement, an antenna measurement, an inductance measurement, a magnetic signal, another type of measurement, or combinations thereof. In some examples, a signal attribute may include a signal strength, a signal duration, a signal amplitude, noise associated with the signal, a pattern of noise accompanying the signal, an interference of the signal, an interference pattern associated with the signal, a resonance of the signal, the frequency of the signal, a polarity of the signal, a reflection of the signal, a voltage of the signal, a change in signal strength of the signal over time, a change in frequency of the signal over time, a change in amplitude of the signal over time, a change in polarity of the signal over time, a modulation of a signal, another change of the signal over time, a peak of the signal, an edge of the signal, a processed signal attribute, an analog signal attribute, another signal attribute, or combinations thereof.

For the purposes of this disclosure, the term “image attribute” may generally refer to an image of the object (e.g., finger, thumb, palm, stylus, external antenna, credit card, phone, mobile device, tag, RFID chip, etc.) being measured. In some examples, an image attribute may include an image length, an image width, an image surface area, a distance between features of the image, an interpolation of the image, a spline of the image, a shape of the spline, a curvature of the spline, a number of knots in the spline, a relative angle between different portions of a spline, a distance between knots of a spline, an image edge attribute, a centroid of the image, a distance between an image edge and an image centroid, a change in signal strength across an image, a location of an edge, a location of a corner of an image, a length of a linear portion of an edge of the image, a location of a linear portion of the edge of the image, a symmetry of an image, an asymmetry of an image, a dimension of an asymmetry of an image, a repeated pattern in the image, a dimension of a segmentation of the image, an image outline, a portion of an image outline, a derivative of an image outline or a portion of an image outline, a number of identification of features of interest in an image, a spacing pattern of features of an image, a spacing distance of features of an image, a density of an image, another image attribute, or combinations thereof.

For the purposes of this disclosure, the term “typing attribute” may generally refer to a dimension attribute, a movement attribute, a signal attribute, an image attribute, a proximity attribute, processed attribute, a raw data attribute, another type of attribute, or combinations thereof. In some cases, a typing prompt may cause a user to bring his or her hands, palms, thumbs, and/or near to a capacitance sensor and/or the embedded antenna. In such an example, the system may recognize a combination of palm, fingers, and thumbs that may hover over a capacitance reference surface, may rest on a capacitance reference surface, may touch a capacitance reference surface, may be to the side of a capacitance reference surface, or combinations thereof. The act of typing may also cause multiple movements in the fingers, thumbs, and palms that occur at a simultaneously or during overlapping time periods. Thus, the typing attribute may include aspects of attributes from the finger, thumbs, and palms.

For the purposes of this disclosure, the term “stored attribute” may generally refer to ab attribute that is stored in the processing resources or that may be accessible through the processing resources. For example, the stored attribute may be accessible to the processing resources and are stored in memory located in the electronic device that incorporated the embedded antenna, a networked location, a remote location, a cloud-based location, another type of location, or combinations thereof. The stored attribute may be an attribute that is from the raw data of a user input or from processed data of a user input or user inputs. In some cases, the stored attribute may be modified based on subsequent user inputs. For example, the stored attribute may be an average, a medium, a minimum, a maximum, a range, or another metric based on one or more user inputs. In some cases, the stored attribute may be determined through machine learning, k-nearest-neighbors models, logistic regression models, decision tree models, random forest models, gradient boosting machines, support vector machines, neural networks, other types of models, other processes, or combinations thereof. In some cases, the stored attribute is associated with a condition. For example, a stored attribute may be an indicator that the user input has a particular condition, such as a pressure input, a gesture input, a touch input, a palm input, a finger input, an antenna input, a card tapping input, a card malfunction input, a non-input, a non-antenna input, another type of condition, or combinations thereof.

For the purposes of this disclosure, the term “embedded antenna” may generally refer to an antenna that is incorporated into an antenna module, a capacitance module, another type of module, an electronic device, or combinations thereof. In one example, the embedded antenna is incorporated into a stack layers of a capacitance module that is incorporated into an electronics device. In certain examples, the capacitance module containing the embedded antenna may be a laptop, a mobile device, a smart phone, a watch, an electronic tablet, a vehicle, another type of electronic device, or combinations thereof. In other examples, the embedded antenna may be incorporated into the electronic device, but is physically separate and distinct from a capacitance module. For example, a laptop may include a capacitance module that is associated with a touch pad and/or a touch screen incorporated into the laptop, and the embedded antenna may be incorporated into the palm rest area of the laptop, but not physically connected to the capacitance module. In some examples where the embedded antenna is not physically connected to the capacitance module, the embedded antenna may be positioned close enough to the capacitance module such that a signal from the antenna may be detected with the capacitance module. In some cases, the capacitance module is associated with a touch screen of the electronic device, and the embedded antenna may or may not be incorporated into the capacitance module.

For the purposes of this disclosure, the term “external antenna” may generally refer to an antenna that is not incorporated into the capacitance module or the electronic device that incorporates the capacitance module. In some cases, the external antenna may communicate with the embedded antenna. For example, the embedded antenna may communicate with the external antenna through an NFC protocol or another suitable protocol. A non-exhaustive list of device that may incorporate an external antenna that is capable of communicating with the embedded antenna include a credit card, an identification card, another type of card containing information, a phone, a mobile device, an electronic table, a watch, a tag, an RFID chip, a wearable device, headphones, key fob, kiosk, payment terminal, a control panel, an authentication device, a charging device, another type of device, or combinations thereof. The external antenna may be a passive antenna, a semi-passive antenna, an active antenna, another type of antenna, or combinations thereof.

For the purposes of this disclosure, the term “polling signal” may generally refer to a signal sent from an embedded antenna to detect whether a device with an external antenna is within a sensing range of the embedded antenna. In some cases, the polling signal may be emitted at a lower power than an interrogation signal, which may be used to exchange data between the embedded antenna and the external antenna. In some cases, if no response is detected in response to a polling signal, the embedded antenna may continue to emit polling signals until a response is received or the embedded antenna may go dormant until embedded antenna is woken up by another device in the capacitance module or the electronic device. In some situations where a signal is received in response to the polling signal, the embedded antenna may send an interrogation signal to exchange data with the external device.

For the purposes of this disclosure, the term “interrogation signal” may generally refer to a signal sent from an embedded antenna to an external antenna to exchange information. The interrogation signal may be sent with a higher power than the polling signal. In some examples, the interrogation signal requests information from the external antenna and/or exchanges data with an external antenna.

For the purposes of this disclosure, the phrase “disabling the embedded antenna” may generally refer to turning the embedded antenna off, ignoring signals received with the embedded antenna, classifying a signal as a non-antenna signal, pausing the transmissions sent with the embedded antenna, powering down the embedded antenna, another function that reduces or minimizes the operation of the embedded antenna, or combinations thereof. In some cases, if the system determines that a received signal (received with embedded antenna, the capacitance electrodes, or both) is indicative of a false positive, the processing resources may cause the embedded antenna to be disabled. In some cases, the embedded antenna may be disabled for a predetermined amount of time after the indication of the false positive is received. For example, a metal ring worn by a user and positioned near the embedded antenna may otherwise respond to a polling signal such that an instruction is sent to the embedded antenna to send an interrogation signal. In such an example, comparing at least one attribute of the received signal generated by the metal ring may be compared to the stored attributes such that the system recognizes the received response is not a user input. In such a situation, the embedded antenna may be disabled or the polling signal may be continued to be emitted rather than switching to emit an interrogation signal.

For the purposes of this disclosure, the phrase “antenna signal pattern” may generally refer to characteristics of the antenna's signal. A non-exhaustive list of signal patterns may include, but not limited to, signal timing, signal power levels, modulation patterns, encoded data, magnetic field alterations, compliance with NFC protocols, resonate frequencies, bandwidth rates, polarization patterns, amplitude patterns, frequency patterns, other characteristics, or combinations thereof.

For the purposes of this disclosure, the phrase “disabling the capacitance electrodes” may generally refer to turning the sense electrodes off, turning the transmitting electrodes off, ignoring signals received with the capacitance electrodes, pausing the transmissions sent with the capacitance electrodes, powering down at least one capacitance electrode, another function that reduces or minimizes the operation of the capacitance electrodes, or combinations thereof. In some cases, if the system determines that the embedded antenna is sending an interrogation signal, the system may also cause the capacitance electrodes to be disabled during the operation of the embedded antenna for a predetermined about of time, during the time period that the embedded antenna is interacting with the external antenna, a variable time period, another time period, or combinations thereof.

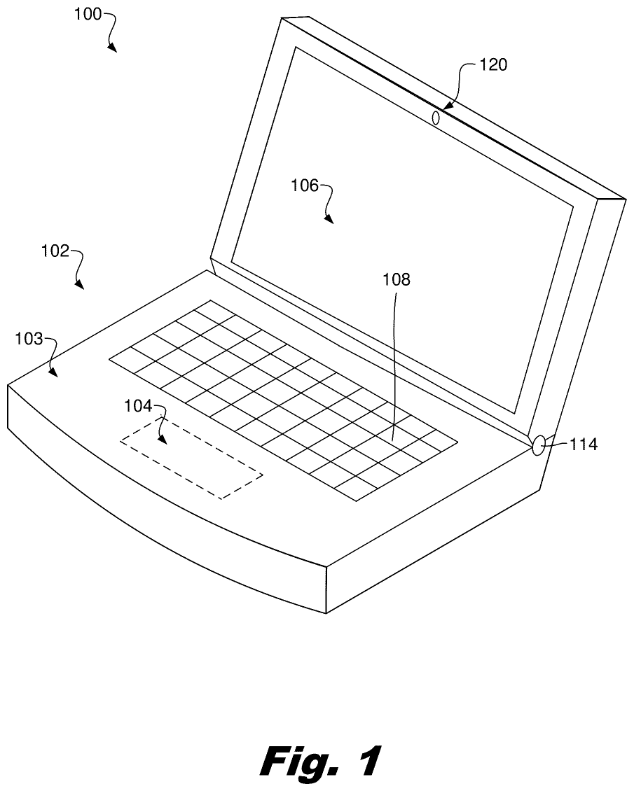

FIG. 1 depicts an example of an electronic device 100. In this example, the electronic device is a laptop. In the illustrated example, the electronic device 100 includes input components, such as a keyboard 102 and a capacitive module, such as a touch pad 104, that are incorporated into a housing 103. The electronic device 100 also includes a display 106. A program operated by the electronic device 100 may be depicted in the display 106 and controlled by a sequence of instructions that are provided by the user through the keyboard 102 and/or through the touch pad 104. An internal battery (not shown) may be used to power the operations of the electronic device 100.

The keyboard 102 includes an arrangement of keys 108 that can be individually selected when a user presses on a key with a sufficient force to cause the key 108 to be depressed towards a switch located underneath the keyboard 102. In response to selecting a key 108, a program may receive instructions on how to operate, such as a word processing program determining which types of words to process. A user may use the touch pad 104 to give different types of instructions to the programs operating on the computing device 100. For example, a cursor depicted in the display 106 may be controlled through the touch pad 104. A user may control the location of the cursor by sliding his or her hand along the surface of the touch pad 104. In some cases, the user may move the cursor to be located at or near an object in the computing device's display and give a command through the touch pad 104 to select that object. For example, the user may provide instructions to select the object by tapping the surface of the touch pad 104 one or more times. In this example, the electronic device 100 also includes a camera 120.

The touch pad 104 is a capacitance module that includes a stack of layers disposed underneath the keyboard housing, underneath an overlay that is fitted into an opening of the keyboard housing, or underneath another capacitive reference surface. In some examples, the capacitance module is located in an area of the keyboard's surface where the user's palms may rest while typing. The capacitance module may include a substrate, such as a printed circuit board or another type of substrate. One of the layers of the capacitance module may include a sensor layer that includes a first set of electrodes oriented in a first direction and a second layer of electrodes oriented in a second direction that is transverse the first direction. These electrodes may be spaced apart and/or electrically isolated from each other. The electrical isolation may be accomplished by depositing at least a portion of the electrodes on different sides of the same substrate or providing dedicated substrates for each set of electrodes. Capacitance may be measured at the overlapping intersections between the different sets of electrodes. However, as an object with a different dielectric value than the surrounding air (e.g., finger, stylus, etc.) approach the intersections between the electrodes, the capacitance between the electrodes may change. This change in capacitance and the associated location of the object in relation to the capacitance module may be calculated to determine where the user is touching or hovering the object within the detection range of the capacitance module. In some examples, the first set of electrodes and the second set of electrodes are equidistantly spaced with respect to each other. Thus, in these examples, the sensitivity of the capacitance module is the same in both directions. However, in other examples, the distance between the electrodes may be non-uniformly spaced to provide greater sensitivity for movements in certain directions.

In some cases, the display 106 is mechanically separate and movable with respect to the keyboard with a connection mechanism 114. In these examples, the display 106 and keyboard 102 may be connected and movable with respect to one another. The display 106 may be movable within a range of 0 degrees to 180 degrees or more with respect to the keyboard 102. In some examples, the display 106 may fold over onto the upper surface of the keyboard 102 when in a closed position, and the display 106 may be folded away from the keyboard 102 when the display 106 is in an operating position. In some examples, the display 106 may be orientable with respect to the keyboard 102 at an angle between 35 to 135 degrees when in use by the user. However, in these examples, the display 106 may be positionable at any angle desired by the user.

In some examples, the display 106 may be a non-touch sensitive display. However, in other examples at least a portion of the display 106 is touch sensitive. In these examples, the touch sensitive display may also include a capacitance module that is located behind an outside surface of the display 106. As a user's finger or other object approaches the touch sensitive screen, the capacitance module may detect a change in capacitance as an input from the user.

While the example of FIG. 1 depicts an example of the electronic device being a laptop, the capacitance sensor and touch surface may be incorporated into any appropriate device. A non-exhaustive list of devices includes, but is not limited to, a desktop, a display, a screen, a kiosk, a computing device, an electronic tablet, a smart phone, a location sensor, a card reading sensor, another type of electronic device, another type of device, or combinations thereof.

In some examples, an NFC antenna is incorporated into the touch pad 104. However, in some examples, at least one NFC antenna is not incorporated into the touch pad but is incorporated into another location of the electronic device, such as, but not limited to, the housing 103, the housing within the palm rest area, within the display 106, a bezel of the display, near the keyboard, under the keyboard, another location in the electronic device, or combinations thereof. In some examples, no NFC antenna is incorporated into the touch pad 104.

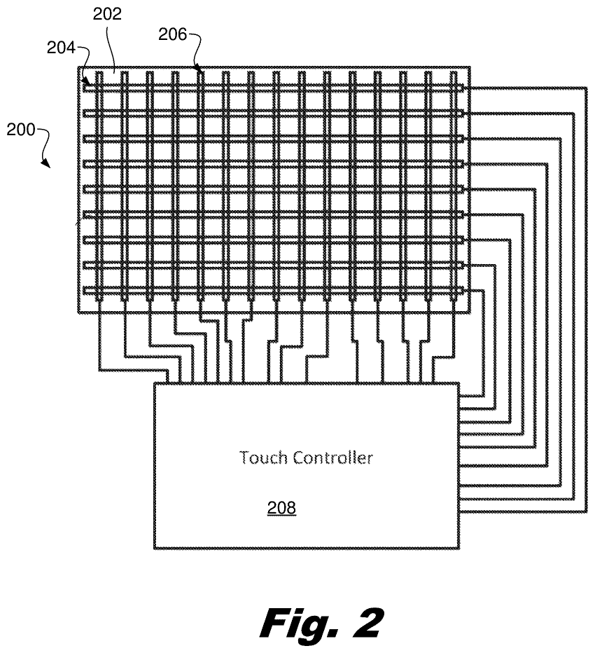

FIG. 2 depicts an example of a portion of a capacitance module 200. In this example, the capacitance module 200 may include a substrate 202, first set 204 of electrodes, and a second set 206 of electrodes. The first and second sets 204, 206 of electrodes may be oriented to be transverse to each other. Further, the first and second sets 204, 206 of electrodes may be electrically isolated from one another so that the electrodes do not short to each other. However, where electrodes from the first set 204 overlap with electrodes from the second set 206, capacitance can be measured. The capacitance module 200 may include one or more electrodes in the first set 204 or the second set 206. Such a substrate 202 and electrode sets may be incorporated into a touch screen, a touch pad, a location sensor, a gaming controller, a button, and/or detection circuitry.

In some examples, the capacitance module 200 is a mutual capacitance sensing device. In such an example, the substrate 202 has a set 204 of row electrodes and a set 206 of column electrodes that define the touch/proximity-sensitive area of the component. In some cases, the component is configured as a rectangular grid of an appropriate number of electrodes (e.g., 8-by-6, 16-by-12, 9-by-15, or the like).

As shown in FIG. 2, the capacitance module 208 includes a capacitance controller 208. The capacitance controller 208 may include at least one of a central processing unit (CPU), a digital signal processor (DSP), an analog front end (AFE) including amplifiers, a peripheral interface controller (PIC), another type of microprocessor, and/or combinations thereof, and may be implemented as an integrated circuit, a field programmable gate array (FPGA), an application specific integrated circuit (ASIC), a combination of logic gate circuitry, other types of digital or analog electrical design components, or combinations thereof, with appropriate circuitry, hardware, firmware, and/or software to choose from available modes of operation.

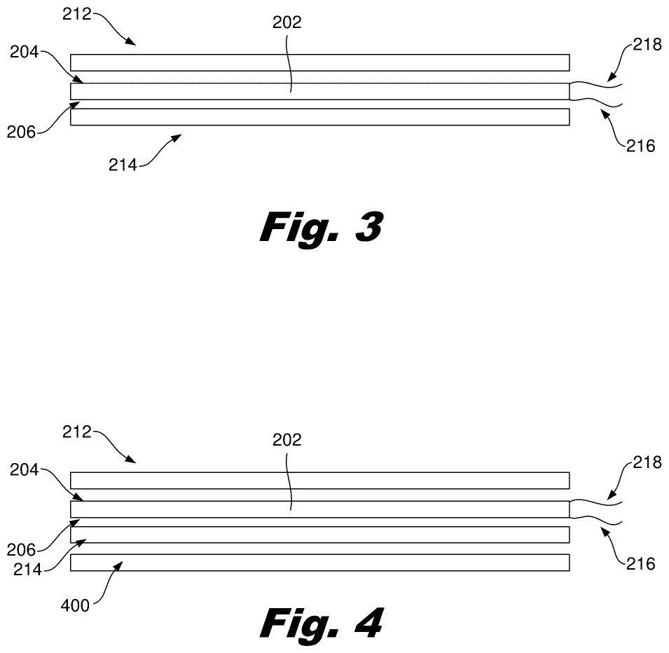

In some cases, the capacitance controller 208 includes at least one multiplexing circuit to alternate which of the sets 204, 206 of electrodes are operating as drive electrodes and sense electrodes. The driving electrodes can be driven one at a time in sequence, or randomly, or drive multiple electrodes at the same time in encoded patterns. Other configurations are possible such as a self-capacitance mode where the electrodes are driven and sensed simultaneously. Electrodes may also be arranged in non-rectangular arrays, such as radial patterns, linear strings, or the like. A shield layer (see FIG. 3) may be provided beneath the electrodes to reduce noise or other interference. The shield may extend beyond the grid of electrodes. Other configurations are also possible.

In some cases, no fixed reference point is used for measurements. The touch controller 208 may generate signals that are sent directly to the first or second sets 204, 206 of electrodes in various patterns.

In some cases, the component does not depend upon an absolute capacitive measurement to determine the location of a finger (or stylus, pointer, or other object) on a surface of the capacitance module 200. The capacitance module 200 may measure an imbalance in electrical charge to the electrode functioning as a sense electrode which can, in some examples, be any of the electrodes designated in either set 204, 206 or, in other examples, with dedicated-sense electrodes. When no pointing object is on or near the capacitance module 200, the capacitance controller 208 may be in a balanced state, and there is no signal on the sense electrode. When a finger or other pointing object creates imbalance because of capacitive coupling, a change in capacitance may occur at the intersections between the sets of electrodes 204, 206 that make up the touch/proximity sensitive area. In some cases, the change in capacitance is measured. However, in alternative example, the absolute capacitance value may be measured.

While this example has been described with the capacitance module 200 having the flexibility of the switching the sets 204, 206 of electrodes between sense and transmit electrodes, in other examples, each set of electrodes is dedicated to either a transmit function or a sense function.

FIG. 3 depicts an example of a substrate 202 with a first set 204 of electrodes and a second set 206 of electrodes deposited on the substrate 202 that is incorporated into a capacitance module. The first set 204 of electrodes and the second set 206 of electrodes may be spaced apart from each other and electrically isolated from each other. In the example depicted in FIG. 3, the first set 204 of electrodes is deposited on a first side of the substrate 202, and the second set 206 of electrodes is deposited on the second side of the substrate 202, where the second side is opposite the first side and spaced apart by the thickness of the substrate 202. The substrate may be made of an electrically insulating material thereby preventing the first and second sets 204, 206 of electrodes from shorting to each other. As depicted in FIG. 2, the first set 204 of electrodes and the second set 206 of electrodes may be oriented transversely to one another. Capacitance measurements may be taken where the intersections with the electrodes from the first set 204 and the second set 206 overlap. In some examples, a voltage may be applied to the transmit electrodes and the voltage of a sense electrode that overlaps with the transmit electrode may be measured. The voltage from the sense electrode may be used to determine the capacitance at the intersection where the sense electrode overlaps with the transmit electrode.

In the example of FIG. 3 depicting a cross section of a capacitance module, the substrate 202 may be located between a capacitance reference surface 212 and a shield 214. The capacitance reference surface 212 may be a covering that is placed over the first side of the substrate 202 and that is at least partially transparent to electric fields. As a user's finger or stylus approach the capacitance reference surface 212, the presence of the finger or the stylus may affect the electric fields on the substrate 202. With the presence of the finger or the stylus, the voltage measured from the sense electrode may be different than when the finger or the stylus are not present. As a result, the change in capacitance may be measured.

The shield 214 may be an electrically conductive layer that shields electric noise from the internal components of the electronic device. This shield may prevent influence on the electric fields on the substrate 202. In some cases, the shield is solid piece of material that is electrically conductive. In other cases, the shield has a substrate and an electrically conductive material disposed on at least one substrate. In some embodiments, the shield layer is positioned between the capacitance electrodes and the component layer to prevent electric fields generated by the components on the component layer from influencing the capacitance electrodes. In some embodiments, the shield layer is positioned between the capacitance electrodes and a battery that is separate from the capacitance module, but is intended to be positioned adjacent to the capacitance module. In this example, the shield may prevent electric fields generated by the battery from influencing the capacitance electrodes. In yet other examples, the shield is layer in the touch pad that performs a function and also shields the electrodes from electrically interfering noise. For example, in some examples, a pixel layer in display applications may form images that are visible through the capacitance reference surface, but also shields the electrodes from the electrical noise.

The voltage applied to the transmit electrodes may be carried through an electrical connection 216 from the touch controller 208 to the appropriate set of electrodes. The voltage applied to the sense electrode through the electric fields generated from the transmit electrode may be detected through the electrical connection 218 from the sense electrodes to the touch controller 208.

While the example of FIG. 3 has been depicted as having both sets of electrodes deposited on a substrate, one set of electrodes deposited on a first side and a second set of electrodes deposited on a second side; in other examples, each set of electrodes may be deposited on its own dedicated substrate.

Further, while the examples above describe a touch pad with a first set of electrodes and a second set of electrodes; in some examples, the capacitance module has a single set of electrodes. In such an example, the electrodes of the sensor layer may function as both the transmit and the receive electrodes. In some cases, a voltage may be applied to an electrode for a duration of time, which changes the capacitance surrounding the electrode. At the conclusion of the duration of time, the application of the voltage is discontinued. Then a voltage may be measured from the same electrode to determine the capacitance. If there is no object (e.g., finger, stylus, etc.) on or in the proximity of the capacitance reference surface, then the measured voltage off of the electrode after the voltage is discontinued may be at a value that is consistent with a baseline capacitance. However, if an object is touching or in proximity to the capacitance reference surface, then the measured voltage may indicate a change in capacitance from the baseline capacitance.

In some examples, the capacitance module has a first set of electrodes and a second set of electrodes and is communication with a controller that is set up to run both mutual capacitance measurements (e.g., using both the first set and the second set of electrodes to take a capacitance measurement) or self-capacitance measurements (e.g., using just one set of electrodes to take a capacitance measurement).

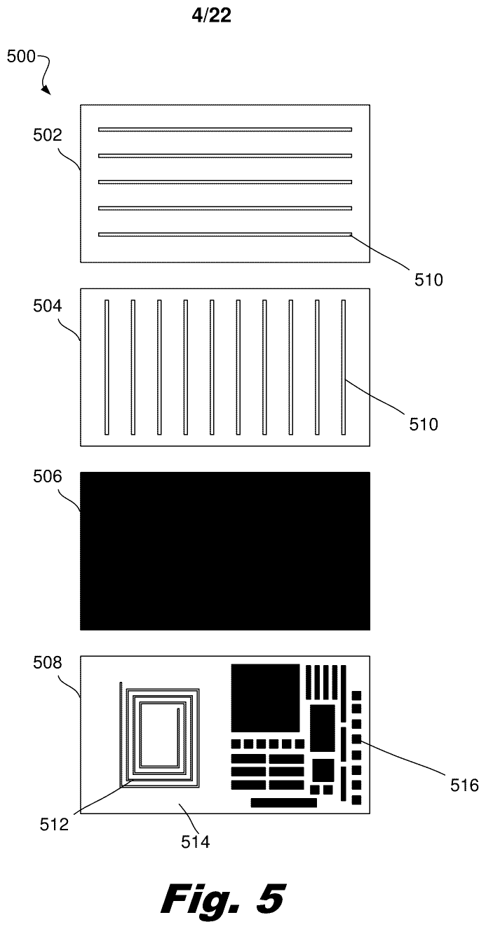

FIG. 4 depicts an example of a capacitance module incorporated into a touch screen. In this example, the substrate 202, sets of electrodes 204, 206, and electrical connections 216, 218 may be similar to the arrangement described in conjunction with FIG. 3. In the example of FIG. 4, the shield 214 is located between the substrate 202 and a display layer 400. The display layer 400 may be a layer of pixels or diodes that illuminate to generate an image. The display layer may be a liquid crystal display, a light emitting diode display, an organic light emitting diode display, an electroluminescent display, a quantum dot light emitting diode display, an incandescent filaments display, a vacuum florescent display, a cathode gas display, another type of display, or combinations thereof. In this example, the shield 214, the substrate 202, and the capacitance reference surface 212 may all be at least partially optically transparent to allow the image depicted in the display layer to be visible to the user through the capacitance reference surface 212. Such a touch screen may be included in a monitor, a display assembly, a laptop, a mobile phone, a mobile device, an electronic tablet, a dashboard, a display panel, an infotainment device, another type of electronic device, or combinations thereof.

FIG. 5 depicts an example of a stack of layers in accordance with the disclosure. In this example, a capacitance module 500 includes a first sensor layer 502, a second sensor layer 504, a shield layer 506, and a component layer 508. While the capacitance module 500 in this example includes four layers, in other examples, a capacitance module may include a different number of layers. For example, a capacitance module may include two layers, three layers, five layers, or a different number of layers.

The first sensor layer 502 and the second sensor layer 504 may be located adjacent to one another. While this example depicts two sensor layers 502, 504, in other examples, a capacitance module may include just a single sensor layer.

The sensor layers 502, 504 may include a set 510 of electrodes that may be used in a capacitance circuit to detect and/or measure changes in capacitance. In this example, the sensor layer 504 includes one set 510 of electrodes. In other examples, a sensor layer may include two sets of electrodes, three sets of electrodes, or a different number of sets of electrodes. The set 510 of electrodes may operate using self-capacitance, mutual capacitance, or combinations thereof.

The shield layer 506 is located adjacent to the sensor layer 504 within the capacitance module 500. In other examples, a shield layer may be in another location relative to other layers in a stack.

The shield layer 506 may be made of a material which blocks or reduces electromagnetic and/or electrical interference. A shield layer may be made of a conductive material such as copper, aluminum, silver, or combinations thereof. A shield layer may be made of a composite material such as plastic, glass, another composite structure, or combinations thereof. A shield layer may be a conductive coating applied to a substrate, such as indium tin oxide (ITO), graphene, a conductive polymer, another coating, or combinations thereof. In some cases, the shield layer may be made of a magnetic material, such as iron, ferrite, another metal, composites thereof, alloys thereof, mixtures thereof, or combinations thereof.

In this example, the shield layer 506 is implemented with a single material. In other examples, a shield layer may be implemented differently. Different implementations of shield layers may offer specific advantages. For example, a shield layer may be implemented as a hatched shield, where a grid or mesh pattern of conductive material is used. Such an implementation may reduce the weight and/or cost of a shield layer while still providing adequate shielding. In another example, a shield layer may be implemented in segments, where sections of conductive material are interspersed with non-conductive gaps. Such an implementation may allow for flexibility in the construction and layout of the capacitance module, potentially improving thermal management and accommodating complex component configurations within the electronic device.

In this example, the shield layer 506 is located between the sensor layer 504 and the component layer 508. The shield layer 506 may help prevent electromagnetic interference originating from components 516 on the component layer 508 or sources external to the capacitance module from interfering with the set 510 of electrodes on the sensor layers 502, 504.

Shielding the sensor layer 504 with the shield layer 506 may improve the accuracy and stability of capacitance measurements measured by the set 510 of electrodes. Shielding the sensor layer 504 may also reduce noise, which may increase the sensitivity and accuracy of user inputs on the capacitance module. The shield layer 506 may be positioned to block interference from a battery, power sources, memory resources, processing resources, electronic components, other components, or combinations thereof that may be positioned within a cavity of the electronic device.

In this example, the component layer 508 is adjacent to the shield layer 506. In other examples, a component layer may be in another location relative to other layers in a stack or parts of a capacitance module. The component layer 508 includes an antenna 512, and other components 516.

Components 516 included on the component layer 508 may facilitate the functionality of the capacitance module 500. Components on a component layer may include a central processing unit (CPU), a microcontroller, an op-amp, a memory unit, a field-programmable gate array (FPGA), a graphics processing unit (GPU), an interface controller, a power management integrated circuit, processing resources, an antenna, another type of component, or combinations thereof.

The antenna 512 may facilitate wireless communication according to a near field communication (NFC) protocol, a wi-fi protocol, a short-range wireless protocol, another wireless protocol, or combinations thereof.

In this example, the component layer 508 includes one antenna 512. In other examples, a layer in a capacitance module may include more than one antenna.

The antenna 512 may be constructed from a highly conductive material to maximize efficiency in signal transmission and reception. In some examples, an antenna may be made of copper, silver, gold, another conductive material, composites thereof, mixtures thereof, alloys thereof, or combinations thereof.

In some examples, the embedded antenna 512 may be deposited on the component layer 508. In other examples, the embedded antenna 512 may be etched into the component layer 508 via a photolithographic process or the like.

An embedded antenna may have any appropriate shape. A non-exhaustive list of suitable antenna shapes include, but is not limited to, coil shapes, dipole shapes, other types of shape, or combinations thereof. The shape of an antenna may correspond to the wireless protocol the antenna is configured to transmit. In this example, the embedded antenna 512 has a coil shape, which may be used to transmit a wireless signal according to the NFC protocol.

The embedded antenna may be used to transmit a signal based on a wireless communication protocol. In other examples, the embedded antenna may be constructed to transmit and/or send signal according to multiple protocols, including but not limited to a Wi-Fi protocol, a short-range wireless protocol, a near field communication (NFC) protocol, Zigbee protocol, another type of protocol, or combinations thereof. In examples there are multiple antennas, each embedded antenna may be used to transmit according to a different protocol.

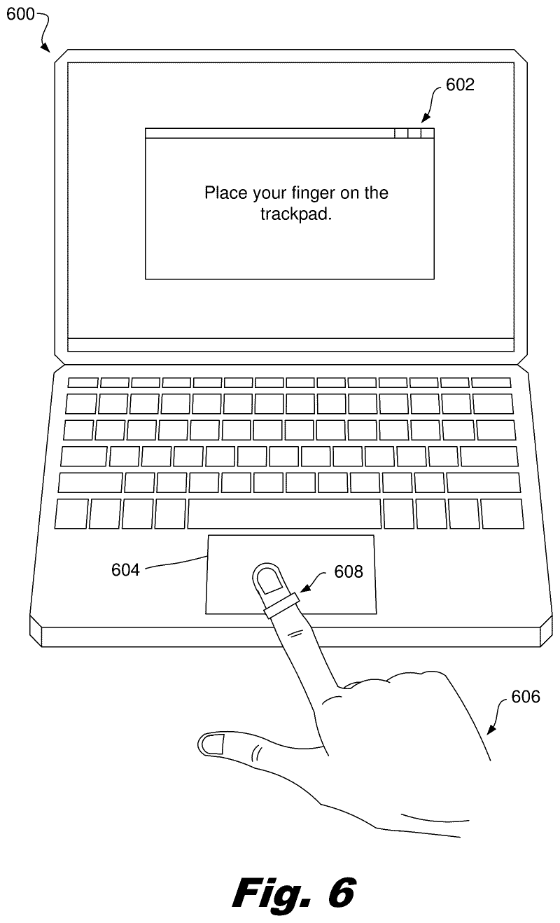

FIG. 6 depicts an example of calibrating an embedded antenna. In this example, the embedded antenna is incorporated into an input device 604 (e.g., a touch pad, capacitance module, an antenna module, another type of input device) of an electronic device 600. In some cases, the input device may include a touch surface. The input device include the capacitance module (not shown) including a stack of layers, which may be located underneath the touch surface of the input device 604 depicted in FIG. 6. In this example, the embedded antenna may be incorporated into the stack of layers or the embedded antenna may be incorporated into electronic device 600, but be separate from the touch pad's capacitance module. In other examples, the capacitance module is incorporated into a display screen. While this example depicts that the electronic device is a laptop, any appropriate electronic device 600 may be used, such a mobile device, an electronic tablet, a phone, a watch, a display, a payment terminal, another appropriate electronic device, or combinations thereof.

The calibration process may include a prompt 602 from the electronic device 600 requesting that the user perform a specific action from which the system can detect a capacitance signature, an antenna signature, another type of signature, or combinations thereof. The system may associate the received signature with the specific action performed by the user. The signature may be broken down into parts and/or features that may become stored attributes that are associated with that specific action. While this illustrated example depicts that the system prompts the user to perform a specific action, the system may use unprompted actions to calibrate the system. For example, the system may determine a user's finger is over or near the embedded antenna through a camera incorporated into the electronic device, through a keyboard input, through a touch input, through a proximity input, from an input from another sensor incorporated into the electronic device, another action, or combinations thereof.

In this particular example, the prompt requests that the user make a touch input on the touch surface. The capacitance electrodes may detect a capacitance signature in response to the user's action of touching the touch surface. In some embodiments, the embedded antenna may detect an antenna signature in response to the user's action of touching the touch surface. In yet other examples, both the capacitance electrodes and the embedded antenna may obtain respective signatures in response to the user's action of placing his or her finger on or near the touch surface.

In the illustrated example, the user is wearing a metal ring 608. This metal ring 608 may cause the capacitance signature and/or the antenna signature to have a specific attribute that would not otherwise be present in the absence of the metal ring 608. In this example, the system may store at least one attribute from the received signature(s) due to the metal ring 608 and associate it with a touch input.

In some cases, the metal ring 608 may have a characteristic shape and/or other property that may cause it to passively respond to a polling signal from the embedded antenna. However, since the metal ring 608 is not an external antenna, it is not desirable for the embedded antenna to boost its power, and/or send interrogation signals in response to the metal ring 608. Thus, the metal ring 608 may cause the embedded antenna to detect a false positive. However, the stored attribute associated with the touch input may help the system determine that the touch input where the user is wearing a ring is not a response from an external antenna. The system may also include at least one stored attribute that is associated with an actual external antenna response, which is a different stored attribute from the touch input. Thus, in response to receiving a passive return signal from a polling signal, the system may compare the received signal to the stored attribute associated with the touch input and also the stored attribute associated with the external antenna response. Based on the comparison of the received signal to each of these stored attributes, the system may determine whether the received response indicates the presence of an external antenna or user touch input (i.e., a false positive external antenna signal).

While a user wearing a metal ring has been described as a reason that may contribute to cause a false positive, other conditions that may at least contribute to causing a false positive may include, but is not limited to, a user wearing watches, fitness trackers, bracelets, other types of jewelry, positioning the electronic device near a metal surface, positioning a metal object near the embedded antenna, another type of condition, or combinations thereof.

In some cases, the system may detect a capacitance measurement around the same time the antenna receives a response to the polling signal. The capacitance measurement may also be compared to stored attributes that are associated with touch inputs and external antennas. In some cases, the system may confirm that the received signal is from an external antenna. In other cases, the system may determine that the received signal is from an external antenna without comparing the received antenna signal with stored antenna signal attributes. In other words, the system may determine that the received signal in response to the antenna polling signal is an external antenna based on the capacitance signature, based on the antenna signature, or both.

In the depicted example, the prompt is requesting that the user make a touch input on the touch surface so that the system may store a stored attribute associated with a touch input. However, the system may prompt the user to perform any appropriate action to obtain a stored attribute. The system may also appropriately associate attributes from received signals to appropriate user actions and/or other types of conditions without prompting the user to perform an action. The system may determine how to classify the signal attributes through other inputs received with the electronic device, such as camera inputs, keyboard inputs, sensor inputs, display screen inputs, capacitance inputs, antenna inputs, and so forth.

In the illustrated example, the prompt is displayed through a display. In other examples, a prompt may be communicated differently. For example, a prompt may be communicated to a user with an audio announcement through a speaker or an audio interface, with haptic feedback through vibrations and/or tactile sensations, by using lights or LED signals, with a text message to a connected device, with another method of communication, or combinations thereof.

While the illustrated example depicts an action of the user touching the touch surface, in other examples, an attribute may be stored for other prompted or unprompted inputs. In some examples, a user action may include a palm input in which the user places his or her palm on a touch surface. In yet other examples, a user action may include a thumb input, another finger input, a multi-finger input, an input that combines a palm input with a finger input simultaneously, a proximity input, a simultaneous input involving both a touch input and a proximity input, touch inputs on certain locations of the touch surface, movement inputs where the user touches the touch surface and moves the touch in a specific way, a rotated input at different angles, other types of inputs, or combinations thereof.

In the depicted example, the input may be a solitary input. In other examples, an input may be a gesture input or combination of gestures. For example, a user may provide a proximity gesture in which he or she places a finger, thumb, palm, stylus, or another object near a capacitance module without making physical contact with the touch surface. In yet other examples, a user may drag a finger from one point on the touch surface to another point on the touch surface. In yet other examples, a user may drag a finger from one point to another on touch surface in a rotating motion. In yet other examples, a user may rest a finger on the touch surface for a specified duration of time. In yet other examples, a user may provide a combination of gestures such as a drag gesture, rotation gesture, and proximity gesture in sequence.

As the user 606 provides the input, the input device 604 may record capacitance and/or antenna measurements corresponding to the input. The measurements may include measurements of the input length, input width, input surface area in contact with the input device reference surface, or combinations thereof. The measurements of the input may include a duration element, such as the duration of the contact between the input and the reference surface of the input device 604.

The measurements of user input during the calibration process may be processed and stored in memory resources of the capacitance module. These measurements may form a reference dataset for the corresponding input.

After obtaining a first stored attribute, a calibration process may repeat these steps to collect measurements and form capacitance reference datasets, antenna reference datasets, or both for different types of user inputs. For example, a user may first be prompted to provide or the user may provide without a prompt, a finger input, a palm input, a thumb input, a proximity input, a touch input, a stylus input, another type of input, or combinations thereof.

A finger input may include touching a reference surface of the input device with a finger. In response to detecting a finger input, the input device may record a capacitance signal strength, multiple capacitance signal strengths at select locations corresponding to a finger shape, a finger length, a finger width, multiple finger widths along the length of the finger, a finger shape, a surface area associated the finger, a finger size, another dimension of the finger shape, another attribute associated with the measured signals from the finger input, or combinations thereof.

A palm input may include touching a touch surface of the input device with a palm of the user's hand. In response to detecting a palm input, the input device may record a capacitance signal strength, multiple capacitance signal strengths at select locations corresponding to a palm shape, a palm length, a palm width, multiple palm widths along the length of the palm, multiple palm lengths along the width of the palm, a palm shape, a surface area associated the palm, a palm size, a location of one or more fingers and/or thumbs protruding from the palm, another dimension of the palm shape, another attribute associated with the measured signals from the palm input, or combinations thereof.

A thumb input may include touching a touch surface of the input device with a thumb. In response to detecting a thumb input, the input device may record a capacitance signal strength, multiple capacitance signal strengths at select locations corresponding to a thumb shape, a thumb length, a thumb width, multiple thumb widths along the length of the thumb, a thumb shape, a surface area associated the thumb, a thumb size, another dimension of the thumb shape, another attribute associated with the measured signals from the thumb input, or combinations thereof.

A stylus input may include touching a touch surface of the input device with an end of a stylus. In response to detecting a stylus input, the input device may record a capacitance signal strength, multiple capacitance signal strengths at select locations corresponding to a stylus shape, a stylus length, a stylus width, multiple stylus widths along the length of the stylus, a stylus shape, a surface area associated the stylus, a stylus size, another dimension of the stylus shape, another attribute associated with the measured signals from the stylus input, or combinations thereof. The user may receive a stylus prompt to use the stylus to write a specific alphanumeric symbol, write a specific phrase, sign the user's name, draw a shape, draw an image, draw a line, draw a circle, draw a pattern, make another type of input with the stylus, or combinations thereof.

A proximity input may include hovering over a touch surface of the input device. For example, a proximity finger input may include hovering a finger over the touch surface of the input device without touching the input device. For example, a proximity thumb input may include hovering a thumb over the touch surface of the input device without touching the input device. For example, a proximity palm input may include hovering a palm over the touch surface of the input device without touching the input device. For example, a proximity stylus input may include hovering a stylus over the reference surface of the input device without touching the input device. A proximity prompt may request that the user swipe his or her hand over the touch surface, make a single finger gesture, make multi-finger gesture, make a single-handed gesture, make a multi-handed gesture, may a gesture, move an object horizontally with respect to the reference surface, move the object vertically with respect to the reference surface, make a circular motion, make another type of motion, or combinations thereof.

In response to detecting a proximity input, the input device may record a capacitance signal strength, multiple capacitance signal strengths at select locations corresponding to an input proximate shape, a proximate shape length, a proximate shape width, multiple widths along the length of the proximate shape, a proximate shape, a surface area associated the proximate shape, a proximate shape size, another dimension of the proximate shape, another attribute associated with the measured signals from the proximate input, or combinations thereof.

An antenna input may include signal strengths, frequencies, changes in frequencies, amplitudes, changes in amplitude, polarities, changes in polarity, power levels, changes in power, bandwidths, return losses, impedance values, gain values, changes in gain, doppler shifts, time delays, phases, changes in phase, multipath effects, other antenna signal attributes, or combinations thereof.

In some cases, the raw data from the inputs may be stored as the attributes. In other examples, the attributes may include processed data. In some examples, the processed attributes may include average lengths, median lengths, maximum lengths, minimum lengths, lengths within the first standard of deviation, average widths, median widths, maximum widths, minimum widths, widths within the first standard of deviation, average surface areas, median surface areas, maximum surface areas, minimum surface areas, surface areas within the first standard of deviation, average capacitance signal strengths, median capacitance signal strengths, maximum capacitance signal strengths, minimum capacitance signal strengths, capacitance signal strengths within the first standard of deviation, average sizes, median capacitance signal strengths, maximum sizes, minimum sizes, sizes within the first standard of deviation, average signal strength, median signal strength, maximum signal strength, minimum signal strength, signal strength within the first standard of deviation, average frequencies, median frequencies, maximum frequencies, minimum frequencies, frequencies within the first standard of deviation, average amplitudes, median amplitudes, maximum amplitudes, minimum amplitudes, amplitudes within the first standard of deviation, average bandwidth, median bandwidth, maximum bandwidth, minimum bandwidth, bandwidth within the first standard of deviation, average return loss, median return loss, maximum return loss, minimum return loss, return loss within the first standard of deviation, average impedance, median impedance, maximum impedance, minimum impedance, impedance within the first standard of deviation, average gain, median gain, maximum gain, minimum gain, gain within the first standard of deviation, average doppler shift, median doppler shift, maximum doppler shift, minimum doppler shift, doppler shift within the first standard of deviation, average time delay, median time delay, maximum time delay, minimum time delay, time delay within the first standard of deviation, other processed attributes, or combinations therefore. In some cases, both raw and processed attributes are stored and/or used to compare against the unprompted user inputs.

During operation of the electronic device, the system may classify capacitance inputs and/or the received antenna inputs by comparing the capacitance inputs with the reference datasets stored in its memory. The comparison may involve evaluating the similarities and differences between the new measurements and the stored attributes. In some examples, the system may use this analysis to classify an unprompted input as signal from an external antenna when at least one of the attributes of the unprompted input matches or is at least similar to one of the external antenna attributes.

This process of measuring, storing, and comparing inputs may allow the input device to distinguish between different types of touch inputs, antenna inputs, other types of inputs, or combinations thereof. Such classifications may help reduce external antenna false positives.

In some cases, in response to a determination that an input is an external antenna input, the system may cause the antenna to send an interrogation signal, boost the antenna's power, interpret a message, decipher a modulation pattern, send a message to the user, inhibit the capacitance electrodes, inhibit another function within the electronic device, perform another action, or combinations thereof.

In some cases, the capacitance attributes may indicate that there is an external antenna. In such an example, the system may cause the antenna to wake up, turn on, send a polling signal, send an interrogation signal, boost an antenna signal, perform another action, or combinations thereof.

In some cases, the comparison against either the store capacitance attributes, the stored antenna attributes, or a combination thereof may lead to the determination that the received antenna signal is a false positive. For example, the comparison may determine that the detected signals are more indicative of a user touch input, a user proximity input, a rain input, environmental input, another condition, or combinations thereof. In response to determining that the received antenna signal is a false positive, the system may ignore the input, reject the input, disable the antenna for a predetermined amount of time, disable a portion of the antenna for a predetermined amount of time, change a sensitivity threshold value of the antenna, fail to rely received antenna signal, send a message to the user, provide another response, or combinations thereof.

During a calibration process, a machine learning models or another type of module may be used to update and/or modify the attributes as more measurements are taken. During operation, capacitance inputs, antenna inputs, or both may be passed to the machine learning models, and the inputs may be classified based, at least in part, on the output of the models.

A machine learning model may be a k-nearest-neighbors model, a logistic regression model, a decision tree model, a random forest model, a gradient boosting machine, a support vector machine, a neural network, another machine learning model, or combinations thereof.

In some examples, a machine learning model may be trained and stored on processing resources and memory belonging to a capacitance module itself. In other examples, a machine learning model may be trained and stored on device resources pertaining to a device in electronic communication with a capacitance module.

The system may cause the calibration process to be initiated when a user sets up his or her profile associated with an electronic device. In some examples, the calibration process may be initiated or updated in response to a user request. In some examples, the calibration process may be initiated or updated in response to an event-based trigger, such as turning on an electronic device, updating software, changing a setting associated with the input device, a program request, a user request, opening a program with the electronic device, updating a user profile, another event-based trigger, successful exchange of information between the embedded antenna and an external antenna, or combinations thereof. In some examples, the calibration process may be re-initiated on a reoccurring basis.

In cases where the calibration process is repeated, the datasets gathered from the previous calibration process may be replaced with datasets from the most recent calibration. However, in other examples, the dataset from the most recent calibration may be used to update or refine processed stored attributes. In other examples, the store attributes may include attributes from multiple calibrations.

In some examples, the stored attributes may be associated with certain conditions such as a damaged card stored attribute, a bent card stored attribute, a misalignment stored attribute, a distance stored attribute, a condition of the external antenna stored attribute, another type of attribute, or combinations thereof. In some response to the comparison with the stored attribute, the system may send a message to the user. The message may be presented in a screen of the electronic device, a text message, an email, a speaker, a tactile stimulation, another mechanism for communicating the message, or combinations thereof. The message may include a notice, a request, another type of message, of combinations thereof. A non-exhaustive list of notices that the system may send include, but are not limited to, notices of damage to the external antenna, damage to the card, that the card is bent, that card's external antenna is degrading, that the card is expired, that the card is nearing the expiration date, that the card is not working, the card is too close to another card with a magnetic strip, the card is too close to another card with a second external antenna, another type of notice, or combinations thereof.

A non-exhaustive list of requests that the system may send include, but are not limited to, requests to center the card over the embedded antenna, reorientation of the card, hold the card at a different angle, move the card closer to the reader, remove the card from out of the user's wallet, remove other cards that may include an interfering signal, another request, or combinations thereof.

In some examples, the calibration process may be helpful in situations where the electronic device is mobile device that is covered with a metal casing or another type of casing that may interfere with the antenna signals. In some cases, the user may operate the electronic device on a metal surface, place the electronic device on a metal surface, place the electronic device in an environment that may interfere with the antenna signal. In some cases, the system may prompt the user to place the electronic device on a metal surface during the calibration process to calibrate for such conditions.

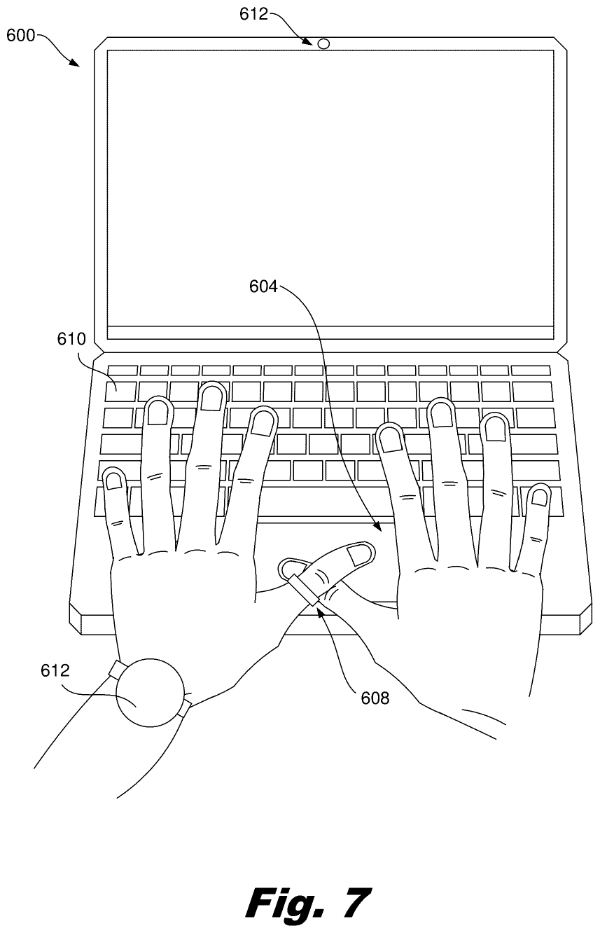

FIG. 7 depicts an example of a user providing a typing input into a keyboard 610 of an electronic device 600. In response to detecting that the user is typing, the system may cause the capacitance module to take a measurement and extract capacitance attributes that may be associated with having a user's palms and fingers near the input device 604. In response to detecting that the user is typing, the system may cause the embedded antenna to take a measurement and extract received antenna signal attributes that may be associated with having a user's palms and fingers near the input device. In situations where the user is wearing a metal ring 608, a watch 612 or another type of jewelry that may contribute to causing a false positive external antenna signal, the system may store capacitance attributes, antenna attribute, or combinations thereof that are associated with the user typing, having his or her fingers near the input device, having his or her palms near the input device, or another condition that can be assumed based on receiving a keyboard input. Later, when an unprompted antenna signal is detected, at least one attribute of the received antenna signal can be compared to stored attributes (stored capacitance or stored antenna attributes) to determine or confirm the presence of an external antenna.

In another example, a camera 612 may detect that the user is making a typing input, has a metal ring near the input device 604, is touching the input device 604, is resting a palm on the input device 604, is using a card with an external antenna near the input device 604, is performing another action that may affect an antenna signal, or combinations thereof. In response to such a camera input, the system may obtain a capacitance signature, an antenna signature, another type of signature, or combinations thereof to extract attributes that be stored for later comparison to other received signals.

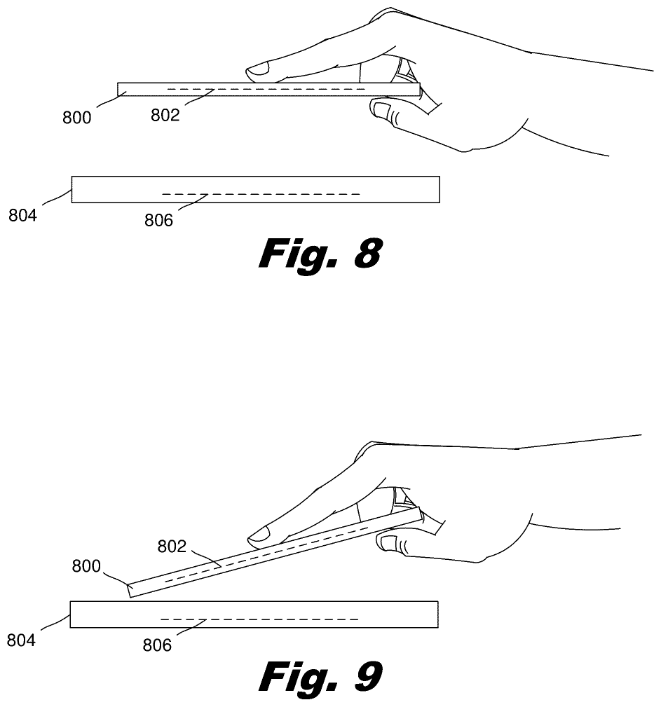

FIG. 8 depicts an example of a user holding a card 800 with an external antenna 802 over an input device 804 that has an embedded antenna 806. In this example, the user may be holding the card 800 so that the external antenna 802 is within a detectable range of the embedded antenna 806.

The embedded antenna may broadcast at low power a polling signal to detect the presence of an external antenna within its detectable range. When no response is received from another external antenna, the system may determine that there is no external antenna within the detectable range. If an external antenna is within the detectable range under some conditions, the electromagnetic energy of the polling signal may passively interact with the external antenna and produce a reflection that is detectable by the embedded antenna. In response to detecting the reflection, the system may determine that the external antenna is within the detectable range of the embedded antenna.

FIG. 9 depicts an example of a user tapping the card 800 on the input device 804. This tapping may produce a vibration or a specific reflection pattern that helps to notify and/or confirm that the external antenna is present. In some cases, tapping the card may just ensure that the card is within the detectable sensing range. In response to the tapping or being within the appropriate detectable sensing range, the embedded antenna may broadcast a polling signal, broadcast an interrogation signal, boost the power of the embedded antenna, decipher a modulation of the external antenna, perform another action, or combinations thereof.

In FIGS. 8 and 9, conditions may exist that interfere with properly identifying whether there is an external antenna within the detectable range, interfere with deciphering a message in a signal from the external antenna, or combinations thereof. For example, if multiple cards with external antennas are within the detectable range, the interrogation signal may receive separate responses from each of the cards'external antenna. This may occur when the user places his or her wallet containing multiple cards near the input device instead of removing the desired card from the wallet. In other cases, the card with the external card may be bent, thereby affecting the signal that the external antenna reflects back. Further, jewelry worn by the user may also affect the external antenna's signal. Each of these conditions may be calibrated by associating attributes from prompted inputs or unprompted inputs (that are confirmed through typing inputs, camera inputs, other types of inputs, or combinations thereof). The calibration process may be ongoing as the system may use at least some of the subsequent inputs to update and/or refine the stored attributes.

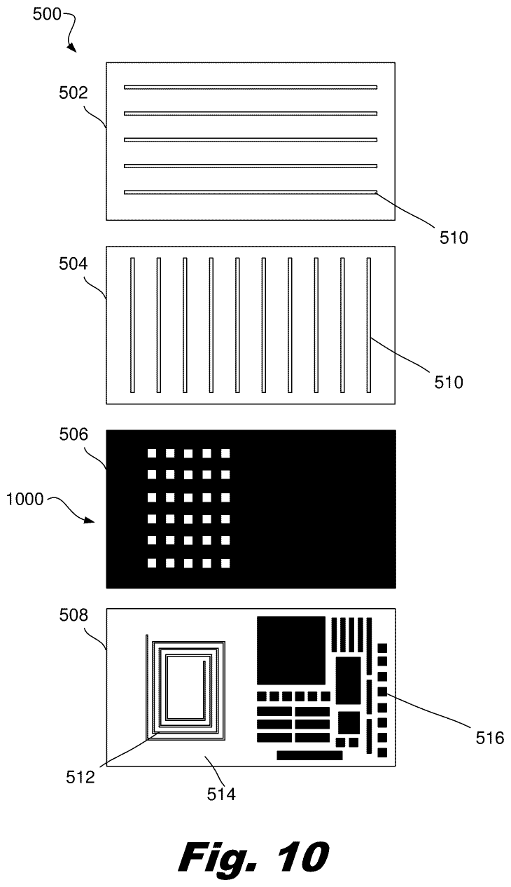

FIG. 10 depicts an alternative capacitance module from the capacitance module depicted in FIG. 5. In this example, the shield layer 506 includes multiple openings 1000 that are constructed to allow at least some of the antenna signal to pass through the shield layer and past the capacitance electrodes. Such openings may assist is improving the transmission of the embedded antenna's signal.

In some cases, the reflected signal from the external antenna may also be detected with the capacitance electrodes. In such an example, the stored attributes may include a time between an embedded antenna signal and a reflected signal, a strength difference between an embedded antenna signal and a reflected signal, a frequency difference between an embedded antenna signal and a reflected signal, an amplitude difference between an embedded antenna signal and a reflected signal, a polarity difference between an embedded antenna signal and a reflected signal, a modulation difference between an embedded antenna signal and a reflected signal, another difference between an embedded antenna signal and a reflected signal, or combinations thereof.

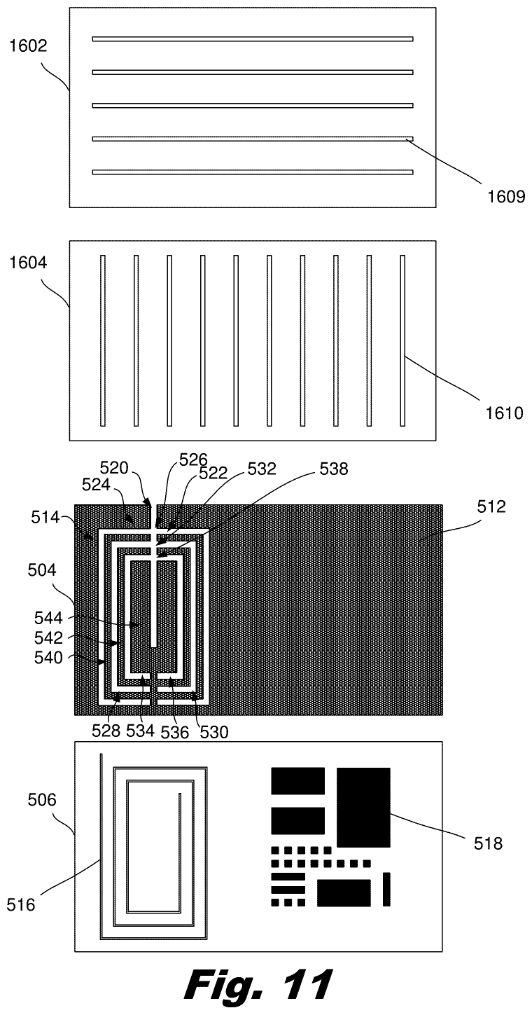

FIG. 11 depicts an alternative capacitance module from the capacitance module depicted in FIG. 5. In this example, the shield layer 506 includes single branched openings 1100 that is constructed to allow at least some of the antenna signal to pass through the shield layer and past the capacitance electrodes. Such an opening may assist in improving the transmission of the embedded antenna's signal. An example of such an opening in described in the U.S. patent application Ser. No. 18/793,152 filed on Aug. 2, 2024, and titled “A Continuous Opening in a Shield Layer. ” U.S. patent application Ser. No. 18/793,152 is incorporated by reference herein for all that it contains.

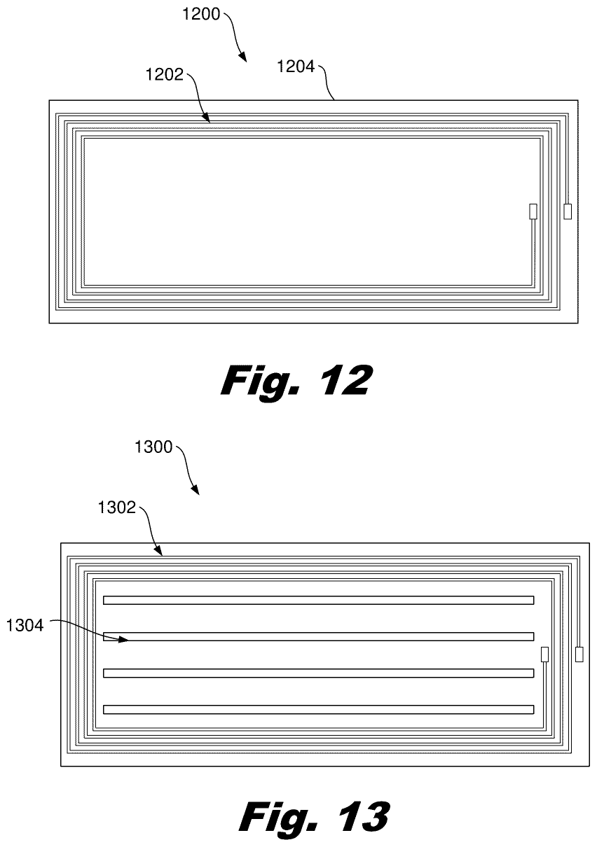

FIG. 12 depicts an example of an antenna module 1200. In this example, the antenna module 1200 includes an embedded antenna 1202 that is on a printed circuit board. In other examples, the embedded antenna may be on a flex printed circuit board, another type of board, or combinations thereof. In this example, there are no capacitance electrodes on the same surface with the embedded antenna 1202. In some examples, there are no capacitance electrodes that are incorporated into the same module with the embedded antenna.

FIG. 13 depicts an example of a module 1300 with an embedded antenna 1302 that surrounds a set of capacitance electrodes 1304. In this example, the embedded antenna 1302 and the capacitance electrodes 1304 are located on the same layer.

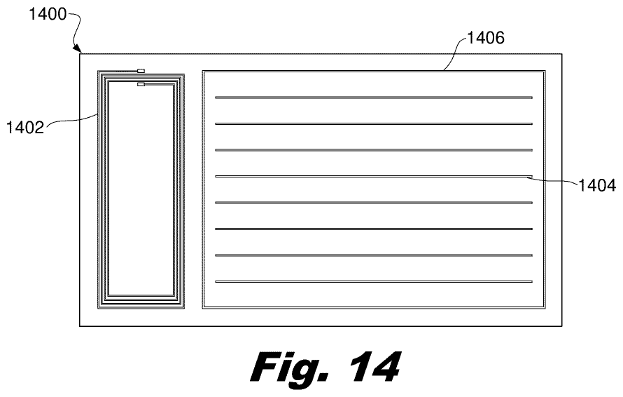

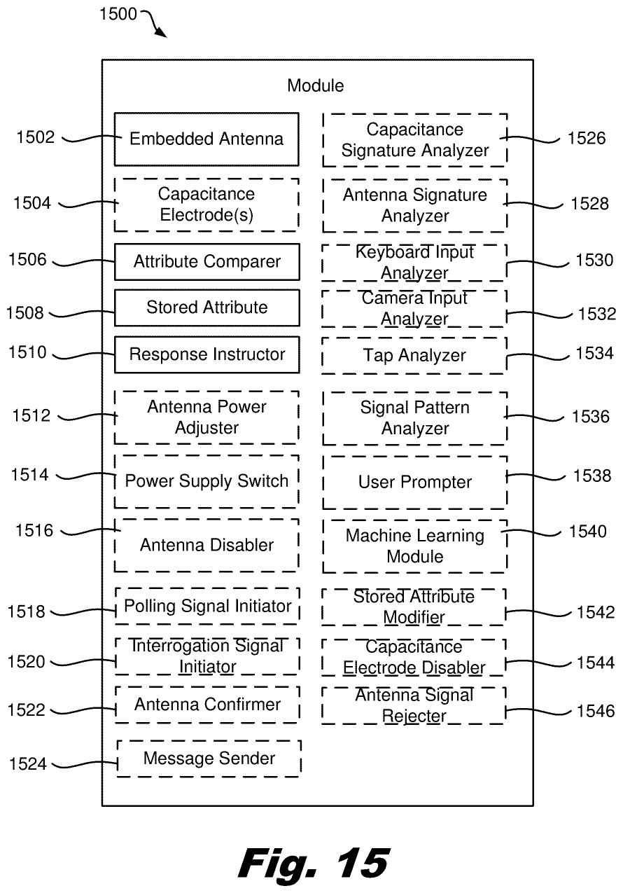

FIG. 14 depicts an example of a module 1400 with an embedded antenna 1402 positioned to the side of a set of capacitance electrodes 1404. In this example, there is a shield 1406 between the set of capacitance electrodes 1404 and the embedded antenna 1402.

FIG. 15 depicts an example of a module 1500. In this example, the module 1500 includes programmed instructions in memory and may include associated firmware, logic, processing resources, memory resources, power sources, hardware, connectors, or other types of components to carry out the tasks of the module 1500. The module 1500 may be used in conjunction with the description of the devices, modules, method, systems, and principles described in relation to FIGS. 1-14 and 16-25. In this example, the module 1500 includes an embedded antenna 1502, an attribute comparer 1514, a stored attribute 1508, and a response instructor 1510.

The module 1500 may optionally include one or more of the following: at least one capacitance electrode 1504, an antenna power adjuster 1512, a power supply switch 1514, an antenna disabler 1516, a polling signal initiator 1518, an interrogation signal initiator 1520, an antenna confirmer 1522, a message sender 1524, a capacitance signal analyzer 1526, an antenna signal analyzer 1528, a keyboard input analyzer 1530, a camera input analyzer 1532, a tap analyzer 1534, a signal pattern analyzer 1536, a user prompter 1538, a machine learning module 1540, a stored attribute modifier 1542, a capacitance electrode disabler 1544, and/or an antenna signal rejecter 1546.

The embedded antenna 1502 may be any suitable antenna, such as an NFC antenna, a Wi-Fi antenna, a Bluetooth antenna, another type of antenna, or combinations thereof. In some cases, the embedded antenna includes a shape that may be used for both receiving and transmitting antenna signals. In some cases, the embedded antenna include a separate transmitter and a separate receiver. In some cases, the embedded antenna is part of an antenna array that may include multiple transmitters, multiple receivers, and/or both.

The capacitance electrode 1504 may be part of a set of electrodes that are configured to measure changes in capacitance. The electrodes may use mutual capacitance protocols, self-capacitance protocols, or other types of protocols to measure changes in capacitance.

An attribute comparer 1506 compares raw input attributes or processed input attributes with stored attributes. The attribute comparer may determine how similar the input attributes are to the stored attributes. Based at least in part on the comparison performed with the attribute comparer, the system may classify the type of input.

The stored attribute 1508 may be an attribute that is derived from at least one of the input signals. The stored attribute may be a raw data attribute or the stored attribute may be a processed attribute. The stored attribute may be updated and/or modified as more inputs are received and analyzed with the capacitance electrodes or with the embedded antenna.

The response instructor 1510 may determine the type of response to take in response to the comparison between the input attribute and the stored attribute. For example, if the input attribute is similar or at least similar enough to a stored attribute associated with a credit card having an external antenna, then the response instructor 1510 may send an instruction to perform a response such as to send an interrogation signal, send a polling signal, turn the antenna on, decipher a message on a received signal, another type of instruction, or combinations thereof. In other examples, the response instructor may determine that the received signal is a false positive received antenna signal. In this example, the response instructor may send a response to disable the antenna for a predetermined amount of time, to reject the received signal, perform another action, or combinations thereof.

The power supply switch 1514 may be used to turn the antenna on or off. The power supply switch may be used in response to determining the presence of an external antenna within the detectable range of the embedded antenna.

The antenna disabler 1516 may cause the embedded antenna to be disabled. The embedded antenna may be disabled by turning off power to the antenna, pausing antenna transmissions, ignoring received signals with the embedded antenna, another action, or combinations thereof.

The polling signal initiator 1518 may cause the embedded antenna to send a polling signal. The polling signal may be of lower power than the interrogation signal and may be used to detect the presence of an external antenna rather than decipher a message from an external antenna.

The interrogation signal initiator 1520 may be used to exchange information between an external antenna and an embedded antenna. The interrogation signal initiator may cause a signal with more power than the polling signal to be sent in response to determining that an external antenna is present within the embedded antenna's detectable range.

The antenna confirmer 1522 may confirm that an antenna is present. For example, the module may determine that the embedded antenna has received a signal. The antenna confirmer may determine that the received signal is from an external antenna rather than from a metal ring, a metal surface, a metal case, a nearby metal object, another object that causes interference, or combinations thereof. The antenna confirmer may confirm that the received signal is from an external antenna by comparing an attribute from the received signal with a stored attribute. The input attribute used to confirm the presence of the antenna may be an antenna attribute, a capacitance attribute, or a combination thereof.

The message sender 1524 may cause a message to be sent to the user. The message may be associated with the stored attribute that matches or is at least similar enough to the input attribute. For example, an input attribute that is determined to be similar to a stored attribute associated with a credit card being held too far away for the system to confidently decipher the external antenna's message may also be associated with a message that instructs the user to move the credit card closer to the embedded antenna.

The capacitance signature analyzer 1526 may analyze the capacitance input. The capacitance signature analyzer may break down the capacitance input into smaller parts, look for relationships between different parts of the capacitance signature, process parts of the capacitance signature, identify capacitance attributes, calculate capacitance attributes, perform another task, or combinations thereof.

The antenna signature analyzer 1528 may analyze the received antenna input. The antenna signature analyzer may break down the antenna input into smaller parts, look for relationships between different parts of the antenna signature, process parts of the antenna signature, identify antenna attributes, calculate antenna attributes, perform another task, or combinations thereof.

The keyboard input analyzer 1530 may determine that the user is making a keyboard input. In response to determining that the user is making a keyboard input, the keyboard input analyzer may determine which key is receiving the keyboard input. In some cases, the identification with the keyboard input analyzer that there is a keyboard input being made may trigger the taking of a capacitance measurement or taking an antenna measurement to obtain input attributes that may be typical for when a user is using the keyboard of an electronic device.

The camera input analyzer 1532 may determine that the user is making a particular type of input. For example, the camera input analyzer may determine that the user is making a touch input with the input device that contains either the capacitance module, the embedded antenna, or both. In response, a capacitance measurement and/or an antenna measurement may be taken and the obtained attributes from the respective measurements may be stored as touch input attributes or may be used to modify the stored touch input attribute. The camera input analyzer may be used to obtain attributes or modify stored attributes associated with other user actions, such as making a non-contact gesture, a typing input, a card input, a card tapping input, a palm input, a combination of a palm and finger input, a thumb input, a multi-touch input, a touch input with jewelry that may affect the antenna signal, other types of inputs, or combinations thereof.

The tap analyzer 1534 may determine that the user is making a tapping input with a credit card or another type of card with an external antenna. In response to determining that the tapping input is being made, the tapping analyzer may send an instruction to take a capacitance measurement and/or antenna measurement to obtain attributes to store or to modify currently stored attributes.

The signal pattern analyzer 1536 may be used to determine the characteristics of a capacitance measurement or a received antenna signal. The analyzed patterns and/or components of the signals/measurements may be used to create stored attributes and/or modify stored attributes.

A user prompter 1538 may be used to prompt the user to perform an action. The action may involve making an input that the system can measure to obtain signal attributes and/or modify signal attributes. An example of prompts that the user prompter may provide include, but are not limited to, a touch input, making a non-contact gesture, a typing input, a card input, a card tapping input, a palm input, a combination of a palm and finger input, a thumb input, a multi-touch input, a touch input with jewelry that may affect the antenna signal, placing the electronic device on a metal surface, placing the electronic device near a metal object, making a particular input with a specific type of jewelry that may cause interference with received antenna signals, another type of prompt, or combinations thereof. In some examples, the prompter uses a display, audio, vibrations, text messages, other types of messages, or combinations thereof.

The learning machine module 1540 may be used to analyze the attributes of the inputs that are received. The learning machine module may understand at least some of the conditions present when the inputs were received so that the attributes can be appropriately classified.

The stored attribute modifier 1542 may be in communication with the learning machine modules. In response to receiving input from the learning machine module, the stored attribute modifier may modify the stored attributes.

The capacitance electrode disabler 1544 may disable at least one capacitance electrode. The capacitance electrode disabler may cause the capacitance electrode to be disabled in response to determining that the embedded antenna is communicating with an external antenna, the user is providing an unintentional palm input, the user is making a typing input, the presence of another condition, or combinations thereof.

The antenna signal rejecter 1546 may cause the received antenna signal to be rejected. In the antenna signal rejector may cause the antenna signal to be rejected under conditions where the stored attributes indicate that the received antenna signal is a false positive. This may occur when the attributes associated with the capacitance measurement and/or the antenna attribute indicate that the user is making inputs into a touch pad or performing another non-antenna related action.

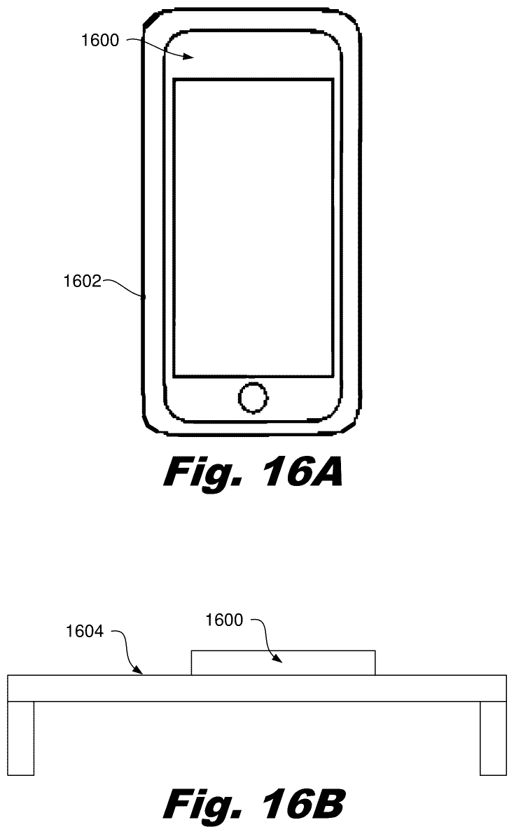

FIG. 16A depicts an example of an electronic device 1600 that has a cover 1602 over at least a portion of the electronic device's outer surface. In some examples, the cover 1602 may be made of a metal that causes interference with the external antenna's return signal.

FIG. 16B depicts an example of the electronic device 1600 being placed on a metal surface 1604. The metal surface may be the surface of a table, a chair, counter, another surface, or combinations thereof. In such an example, the metal surface 1604 may interfere with the external antenna's return signal.

In examples like those depicted in FIGS. 16A and 16B, the calibration systems, modules, devices, electronic devices, and methods described herein may be useful for determining the unique antenna signatures and/or capacitance signatures that may be received, at least in part, due to the cover 1602, metal surface 1604, or other nearby objects that may interfere with the received signals.

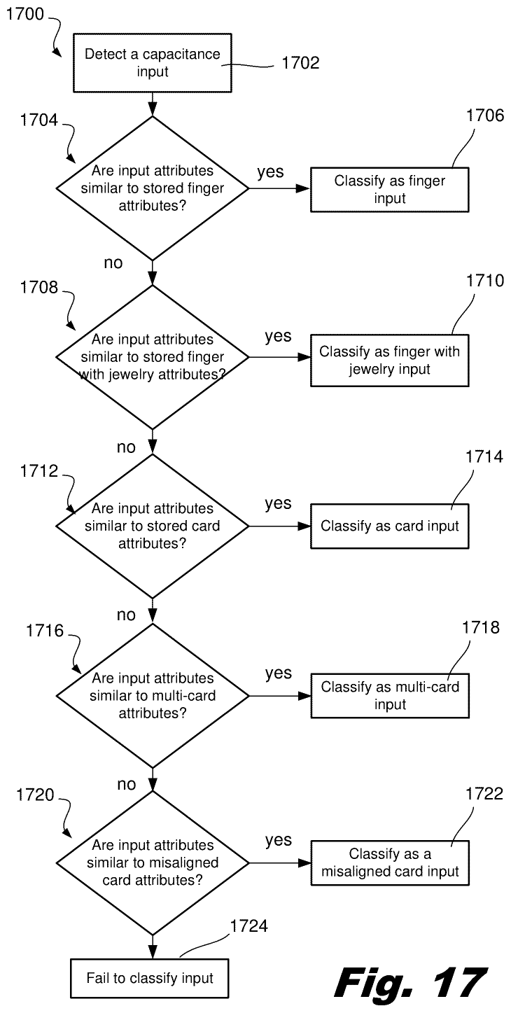

FIG. 17 depicts an example of a method 1700 for using an antenna. This method 1700 may be performed based on the description of the devices, modules, and principles described in relation to FIGS. 1-16. The method 1700 may include detecting 1702 a capacitance input and determining 1704 whether the input attributes of the capacitance input are similar to stored finger attributes. If so, then the method 1700 may include classifying 1706 the input as a finger. If not, then the method 1700 may include determining 1708 whether the input attributes of the capacitance input are similar to stored finger with jewelry attributes. If so, then the method 1700 may include classifying 1710 the input as a finger with jewelry attribute. If not, then the method 1700 may include determining 1712 whether the input attributes of the capacitance input are similar to stored card attributes. In some examples, the card is a card with an external antenna. If so, then the method 1700 may include classifying 1714 the input as a card attribute. If not, then the method 1700 may include determining 1716 whether the input attributes of the capacitance input are similar to stored multi-card attributes. If so, then the method 1700 may include classifying 1718 the input as a multi-card attribute. If not, then the method 1700 may include determining 1720 whether the input attributes of the capacitance input are similar to stored misaligned card attributes. If so, then the method 1700 may include classifying 1722 the input as a misaligned card attribute. In this particular example, if the input attributes fail to be similar to the stored attributes, then the method 1700 include failing 1724 to classify the input.

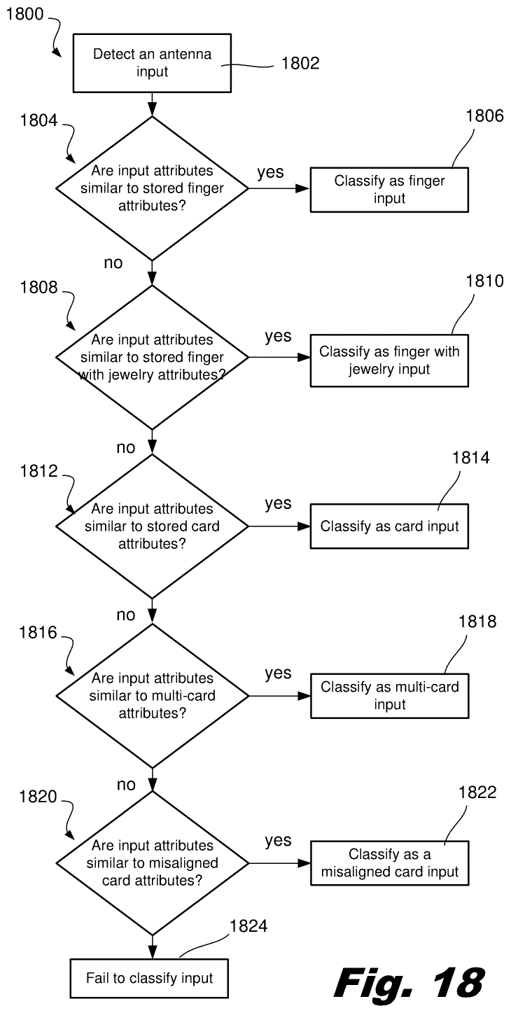

FIG. 18 depicts an example of a method 1800 for using an antenna. This method 1800 may be performed based on the description of the devices, modules, and principles described in relation to FIGS. 1-17. The method 1800 may include detecting 1802 an antenna input and determining 1804 whether the input attributes of the capacitance input are similar to stored finger attributes. If so, then the method 1800 may include classifying 1806 the input as a finger. If not, then the method 1800 may include determining 1808 whether the input attributes of the capacitance input are similar to stored finger with jewelry attributes. If so, then the method 1800 may include classifying 1810 the input as a finger with jewelry attribute. If not, then the method 1800 may include determining 1812 whether the input attributes of the capacitance input are similar to stored card attributes. In some examples, the card is a card with an external antenna. If so, then the method 1800 may include classifying 1814 the input as a card attribute. If not, then the method 1800 may include determining 1816 whether the input attributes of the capacitance input are similar to stored multi-card attributes. If so, then the method 1800 may include classifying 1818 the input as a multi-card attribute. If not, then the method 1800 may include determining 1820 whether the input attributes of the capacitance input are similar to stored misaligned card attributes. If so, then the method 1800 may include classifying 1822 the input as a misaligned card attribute. In this particular example, if the input attributes fail to be similar to the stored attributes, then the method 1800 include failing 1824 to classify the input.

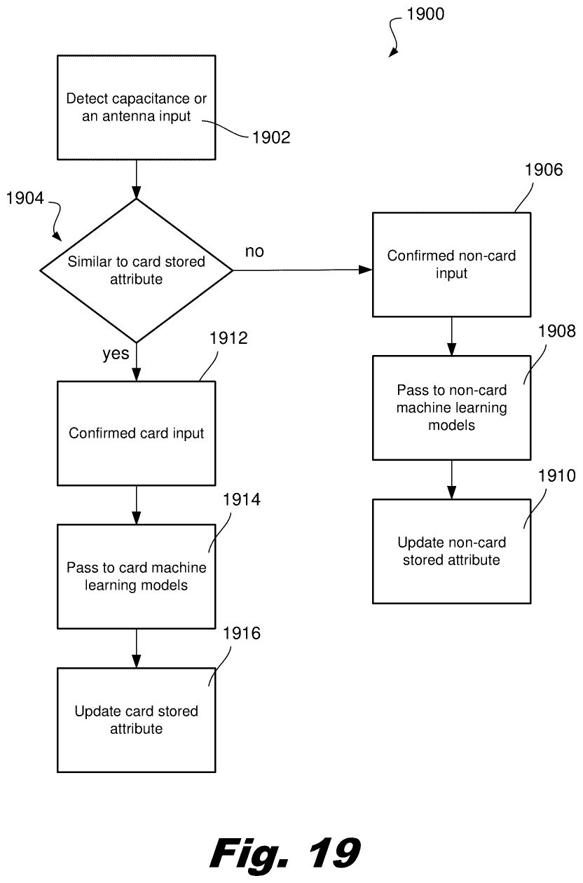

FIG. 19 depicts an example of a method 1900 for using an antenna. This method 1900 may be performed based on the description of the devices, modules, and principles described in relation to FIGS. 1-18. The method 1900 may include detecting 1902 a capacitance or an antenna input and determining 1904 whether an attribute of the capacitance or antenna input is similar to a card attribute. In some examples, the card is a card with an external antenna. If not, then the method 1900 include confirming 1906 that the input is a non-card input, passing 1908 the input (or at least one attribute of the input) to one or more non-card learning machine models, and updating 1910 at least one non-card stored attribute. If so, then the method 1900 include confirming 1912 that the input is a card input, passing 1914 the input (or at least one attribute of the input) to one or more card learning machine models, and updating 1916 at least one card stored attribute.

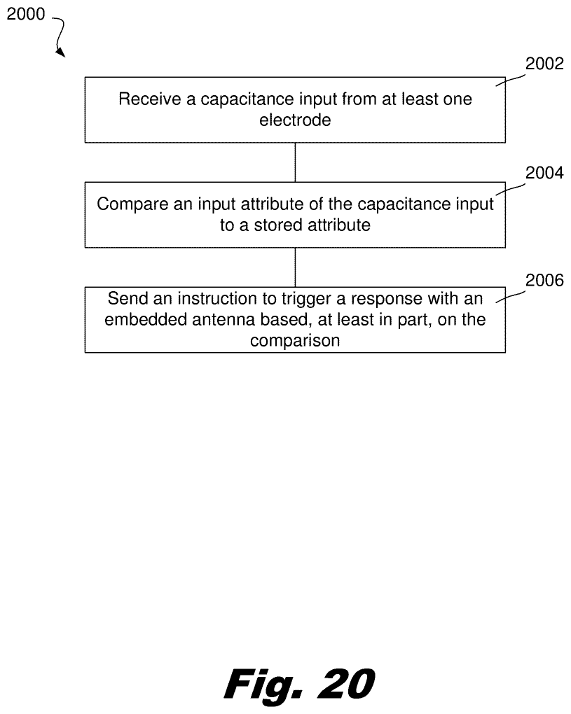

FIG. 20 depicts an example of a method 2000 for using an antenna. This method 2000 may be performed based on the description of the devices, modules, and principles described in relation to FIGS. 1-19. The method 2000 may include receiving 2002 a capacitance input from at least one electrode; comparing 2004 an input attribute of the capacitance input to a stored attribute; sending 2006 an instruction to trigger a response with an embedded antenna based, at least in part, on the comparison.

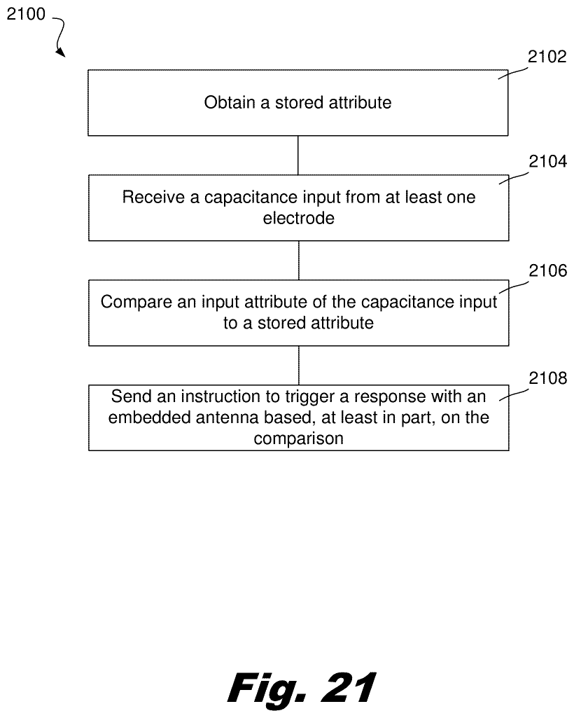

FIG. 21 depicts an example of a method 2100 for using an antenna. This method 2100 may be performed based on the description of the devices, modules, and principles described in relation to FIGS. 1-20. The method 2100 may include obtaining 2102 a stored attribute, receiving 2104 a capacitance input from a least one capacitance electrode; comparing 2106 an input attribute of the capacitance input to a stored attribute; and sending 2108 an instruction to trigger a response with an embedded antenna based, at least in part, on the comparison.

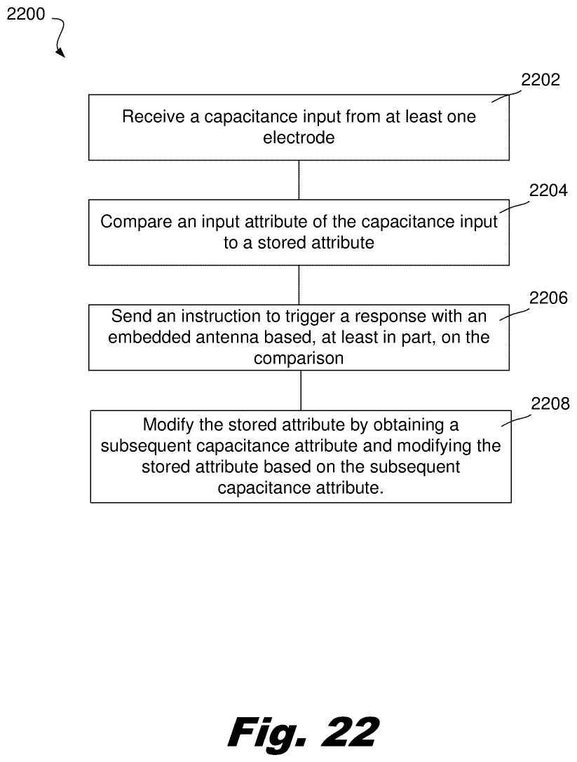

FIG. 22 depicts an example of a method 2200 for using an antenna. This method 2200 may be performed based on the description of the devices, modules, and principles described in relation to FIGS. 1-21. The method 2200 may include receiving 2202 a capacitance input from at least one electrode; comparing 2204 an input attribute of the capacitance input to a stored attribute; sending 2206 an instruction to trigger a response with an embedded antenna based, at least in part, on the comparison; and modifying 2508 the stored attribute by obtaining a subsequent capacitance attribute and modifying the stored attribute based on the subsequent capacitance attribute.

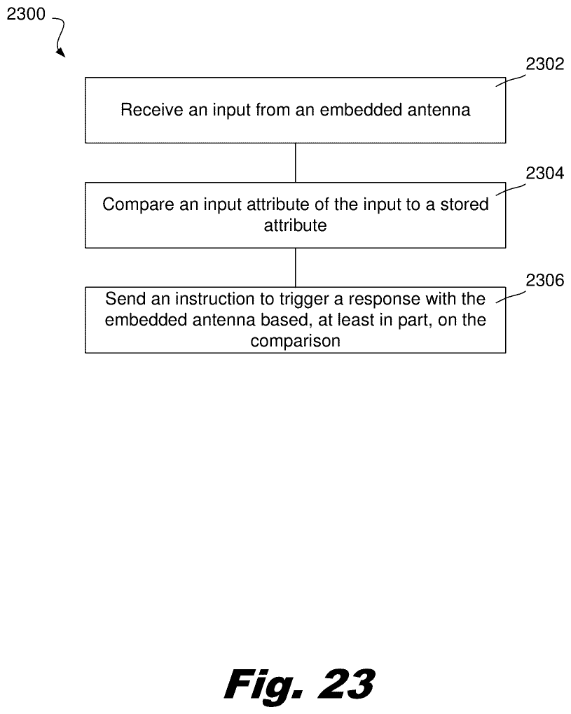

FIG. 23 depicts an example of a method 2300 for using an antenna. This method 2300 may be performed based on the description of the devices, modules, and principles described in relation to FIGS. 1-22. The method 2300 may include receiving 2302 an input from an embedded antenna; comparing 2304 an input attribute of the input to a stored attribute; and sending 2306 an instruction to trigger a response with the embedded antenna based, at least in part, on the comparison.

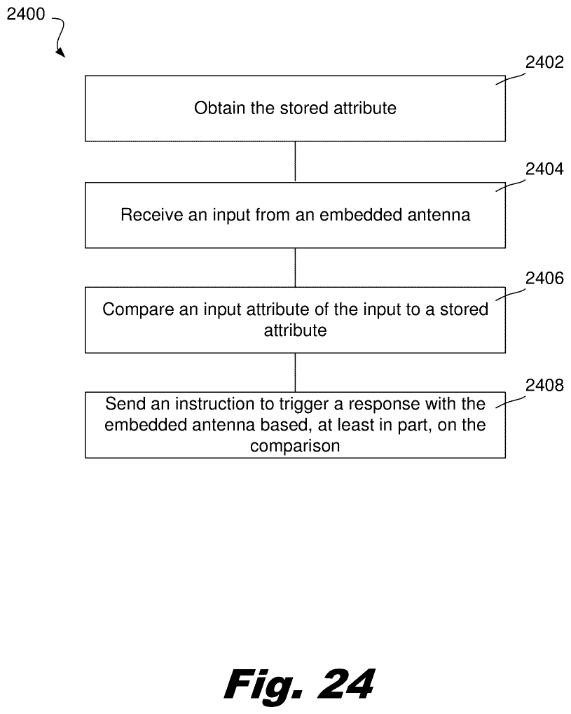

FIG. 24 depicts an example of a method 2400 for using an antenna. This method 2400 may be performed based on the description of the devices, modules, and principles described in relation to FIGS. 1-23. The method 2400 may include obtaining 2402 a stored attribute, receiving 2404 an input from an embedded antenna; comparing 2406 an input attribute of the input to a stored attribute; and sending 2408 an instruction to trigger a response with the embedded antenna based, at least in part, on the comparison.

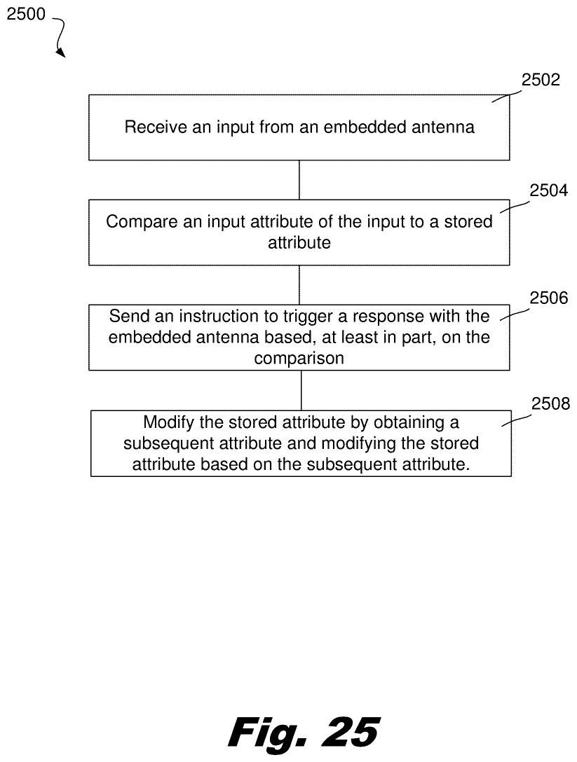

FIG. 25 depicts an example of a method 2500 for using an antenna. This method 2500 may be performed based on the description of the devices, modules, and principles described in relation to FIGS. 1-24. The method 2500 may include receiving 2502 an input from an embedded antenna; comparing 2504 an input attribute of the input to a stored attribute; sending 2506 an instruction to trigger a response with the embedded antenna based, at least in part, on the comparison; and modifying 2508 the stored attribute by obtaining a subsequent attribute and modifying the stored attribute based on the subsequent attribute.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1. A capacitance module, comprising:
a set of electrodes;
processing resources in communication with the set of electrodes;
an embedded antenna in communication with the processing resources; and
memory in communication with the processing resources;
wherein the memory includes programmed instructions that cause the processing resources, when executed, to:
receive a capacitance input from the set of electrodes;
compare an input attribute of the capacitance input to a stored attribute; and
send an instruction to trigger a response with the embedded antenna based, at least in part, on the comparison.

2. The capacitance module of claim 1, wherein the response includes increasing the power level of the embedded antenna.

3. The capacitance module of claim 1, wherein the response includes turning on the embedded antenna.

4. The capacitance module of claim 1, wherein the response includes disabling the embedded antenna.

5. The capacitance module of claim 1, wherein the response includes deciphering a modulation pattern from an external antenna device with the embedded antenna.

6. The capacitance module of claim 1, wherein the response includes sending an instruction to cause the embedded antenna to send a polling signal.

7. The capacitance module of claim 1, wherein the response includes sending an instruction to cause the embedded antenna to send an interrogation signal.

8. The capacitance module of claim 1, wherein the response includes confirming a presence of an external antenna device within a range of the embedded antenna.

9. The capacitance module of claim 1, wherein the programmed instructions further cause the processing resources to obtain the stored attribute.

10. The capacitance module of claim 9, wherein obtaining the stored attribute includes recording a capacitance signature with the capacitance electrodes in response to receiving a camera input from a camera that is incorporated into an electronic device that also incorporates the capacitance module.

11. The capacitance module of claim 9, wherein obtaining the stored attribute includes recording a capacitance signature with the embedded antenna in response to a tap on the electronic device incorporating the capacitance module.

12. The capacitance module of claim 9, wherein obtaining the stored attribute includes recording a capacitance signature with the capacitance electrodes in response to prompting a user to perform an action with the electronic device that incorporates the capacitance module.

13. The capacitance module of claim 1, wherein the programmed instructions further include modifying the stored attribute by obtaining a subsequent attribute and modifying the stored attribute based on the subsequent attribute.

14. A computer-program product for using a capacitance module; the computer-program product comprising a non-transitory computer-readable medium storing instructions executable by a controller to:
receive a capacitance input from the set of electrodes;
compare an input attribute of the capacitance input to a stored attribute; and
send an instruction to trigger a response with an embedded antenna based, at least in part, on the comparison.

15. The computer-program product of claim 14, wherein the response includes disabling the embedded antenna.

16. The computer-program product of claim 14, wherein the response includes confirming a presence of an external antenna device within a range of the embedded antenna.

17. The computer-program product of claim 14, wherein the programmed instructions further cause the processing resources to obtain the stored attribute.

18. The computer-program product of claim 14, wherein the programmed instructions further cause the processing resources to modify the stored attribute by obtaining a subsequent attribute and modifying the stored attribute based on the subsequent attribute.

19. The computer-program product of claim 14, wherein the programmed instructions further cause the processing resources to record a capacitance signature with the embedded antenna in response to a tap on an electronic device incorporating the capacitance module.

20. A method of using a capacitance module, comprising:
receiving a capacitance input from the set of electrodes;
comparing an input attribute of the capacitance input to a stored attribute; and
sending an instruction to trigger a response with an embedded antenna based, at least in part, on the comparison.
